(19) United States
(12) Patent Application Publication
(10) Pub. No.: US 2025/0101178 A1
(43) Pub. Date: Mar. 27, 2025

(54) HIGH MOLECULAR WEIGHT POLYESTERAMIDES

(71) Applicant: SOLUTIA INC., ST. LOUIS, MO (US)

(72) Inventors: ARISTOTELIS KARAGIANNIS, AMHERST, MA (US); PINGUAN ZHENG, JOHNSON CITY, TN (US); SCOTT ELLERY GEORGE, KINGSPORT, TN (US); OLIVIER ETIENNE HILAIRE GEERT VERKINDEREN, WICHELEN (BE); KIM NAZ ROSEMARIE DUMOLEIJN, EEDE (NL); JOSHUA SETH CANNON, GREENEVILLE, TN (US); PU ZHANG, SUFFIELD, CT (US); KHANH DUC TRAN, SOUTH HADLEY, MA (US)

(73) Assignee: SOLUTIA INC., ST. LOUIS, MO (US)

(21) Appl. No.: 18/684,707

(22) PCT Filed: Aug. 3, 2022
(86) PCT No.: PCT/US2022/074456

§ 371 Date: Feb. 19, 2024

Related U.S. Application Data
(60) Provisional application No. 63/260,415, filed on Aug. 19, 2021.

(51) Int. Cl. C08G 69/44; C08J 5/22

(52) U.S. Cl. CPC C08G 69/44; C08J 5/22; C08J 2377/12

(57) ABSTRACT

The invention provides certain polyesteramide compositions which have glass transition temperatures (T_{g}) of greater than or equal to 0° C. The polyesteramides of the invention are useful as polymeric interlayers for laminate structures, for example, safety glass, where excellent toughness is combined with high adhesion to glass.

### FIELD OF THE INVENTION

The invention relates generally to the field of polymer science. More particularly, the invention relates to high molecular weight polyesteramides, which are useful, inter alia, as polymeric interlayers in laminate structures.

### BACKGROUND OF THE INVENTION

Thermoplastic polymers are useful in a wide variety of applications, including, for example, various electrical, automotive, medical, consumer, industrial, and packaging applications. Thermoplastic polymers are advantaged over thermoset plastics in that thermoplastic polymers can be easily melt processed into a variety of useful articles.

Each of the classes of thermoplastic polymers have different properties which make them desirable for certain end uses. Elastomeric thermoplastic polymers generally have glass transition temperature values below room temperature and low modulus values, thereby making them suitable for applications requiring flexibility and stretchability. In contrast, rigid thermoplastic polymers generally have glass transition temperature values above room temperature and high modulus values, which make them suitable for applications requiring stiffness and strength.

Polyesteramides are one class of thermoplastic polymers which are formed from the polycondensation of diacids, diols, and diamines (See, e.g., WO2008112833, U.S. Pat. Nos. 5,672,676 and 2,281,415, and CA2317747). Polyesteramides have attracted strong industrial interest primarily because of their excellent heat resistance properties (see U.S. Pat. No. 5,672,676), their amenability to processing and their potential for biodegradability (see WO2008112833).

Polymer sheets can be used as interlayers in multiple layer panels formed by sandwiching the interlayer between two panes of rigid, transparent materials such as glass. Such laminated multiple layer panels are commonly referred to as “safety glass” and have use in both architectural and automotive applications. One of the primary functions of the interlayer in a safety glass panel is to absorb energy resulting from impact to the panel without allowing penetration of an object through the glass. The interlayer also helps keep the glass bonded when the applied force is sufficient to break the glass in order to prevent the glass from forming sharp pieces and scattering. Additionally, the interlayer can provide the laminated panel with higher sound insulation properties, reduce the ultraviolet (UV) and/or infrared (IR) light transmission through the panel, and enhance its aesthetic appeal through the addition of color, textures, etc.

Often, when a polymeric interlayer exhibits a desirable property, such as rigidity, it may lack other desirable or important properties, such as impact resistance or optical clarity. In some applications, safety glass panels may be used as a structural element, but it may also be required to impart aesthetic characteristics to the application. In such cases, an optimal optical performance, rigidity, and impact resistance is not only desirable, but required. Unfortunately, as the rigidity of conventional interlayers is increased, the impact resistance of the resulting panel generally worsens. Similarly, conventional interlayers formulated for enhanced impact strength often lack necessary rigidity that is required in many applications, such as applications requiring excellent structural support properties.

An emerging market in architectural laminated glass requires interlayers with structural properties such as load bearing ability. Such an interlayer is Eastman's Saflex® DG structural interlayer, which is comprised of plasticized polyvinyl butyral (“PVB”). Generally, structural interlayers are stiffer products than standard PVB interlayers and this higher stiffness allows laminates made with structural interlayers to sustain higher loads. Alternatively, structural interlayers can be used to allow a reduction in the glass thickness while achieving the same laminate loading-bearing capabilities.

Higher performance structural interlayers are desirable as more applications requiring stiffer interlayers are emerging (e.g., single side balcony laminates, canopies, staircases, and support beams). However, some of the commercially-available interlayers exhibit deficiencies in terms of processability and/or functionality. Further, the attraction of glass in many of these structural applications is the clarity of the glass panel. Thus, the layers or interlayers must also not hinder the optical properties of the structural glass articles in which they are incorporated.

Additionally, lighter weight and/or lower cost laminates are desirable for many applications. These lighter weight laminates must still possess the desired physical and optical properties, such as having required impact protection, clarity and other properties. One way to achieve a lighter weight laminate is to reduce the thickness of glass. However, if the thickness of glass is reduced too much, the rigidity of the laminate may be compromised. Higher rigidity interlayers can then be used to restore part of the lost rigidity and result in a lighter weight but acceptably performing laminate. Another way to reduce laminate weight is to eliminate one or more panes of glass and replace them by rigid, transparent plastic panes of sufficiently high rigidity to maintain the integrity of the laminate as well as desirable optical properties.

Thus, a need exists for polymeric interlayers which exhibit strength and rigidity, while still providing sufficient impact resistance. Ideally, such interlayers would also exhibit desirable optical properties, such as low haze and no yellowing. Desirably, these interlayers could be used in multiple layer panels for a wide range of applications, including architectural applications, and would provide an optimized balance of structural and optical performance as well as aesthetic properties.

### SUMMARY OF THE INVENTION

There is a continuing need for polymers with excellent toughness and clarity for improved glass interlayers. Polyesteramides (PEA) of the present invention, as illustrated below, combine the toughness of polyesters with the adhesion properties of polyamides. Attainment of high molecular weight in a melt phase process for manufacturing polyesteramides is problematic because there are few end groups remaining and the stoichiometric control of non-volatile diacids, diamines and glycols becomes impractical. Addition of branchers and/or crosslinkers generally results in a broad molecular weight distribution and a more brittle polymer. We have discovered that the use of certain chain extenders, which react with a plurality of the available functional groups without the concomitant excessive branching of the polymer experienced with branching compounds and/or crosslinkers, provides improved polyesteramide compositions with desirable properties.

In summary, the invention provides certain polyesteramide compositions which have glass transition temperatures (T_{g}) of greater than or equal to 0° C. The polyesteramides of the invention are useful as polymeric interlayers for laminate structures, for example, safety glass, where excellent toughness is combined with high adhesion to glass.

Accordingly, in a first aspect, the invention provides a polyesteramide composition comprising residues of:
a. at least one diacid;
b. about 10 to about 90 mole percent of a glycol;
c. about 10 to about 90 mole percent of a diamine; and optionally
d. a multifunctional reactant having at least three functional groups chosen from carboxylic acid, amine, and hydroxyl groups;
wherein the sum of diacid equivalents is about 100 mole percent and the sum of diol and diamine equivalents is about 100 mole percent; and
e. about 0.01 to about 10 weight percent, based on the total weight of the polyesteramide composition comprised of a., b., c., and optionally d., of a chain extender which is reactive with groups chosen from carboxyl, amino, and hydroxyl groups,
   and wherein the polyesteramide composition exhibits an inherent viscosity of about 0.6 to about 2.0 dL/g.

In this invention, components a., b., c. and e., are present in the polyesteramide composition, with only component d. being an optional component.

Additionally, the polyesteramide compositions of the invention are useful in the manufacture of shaped or formed thermoplastic articles. Accordingly, in a second aspect, the invention provides the polyesteramide composition of the invention in the form of a shaped or formed article. In one embodiment, the shaped or formed article is a film or sheet.

In a third aspect, the invention provides an interlayer comprised of the polyesteramide compositions of the invention.

In a fourth aspect, the invention provides the interlayers of the invention disposed between two panels, thereby forming a laminate structure.

### BRIEF DESCRIPTION OF THE DRAWINGS

FIG. 1 is the current/rpm ratio of batches made with and without chain extender, corresponding to Examples 2 (comparative) and 3.

### DETAILED DESCRIPTION OF THE INVENTION

### Definitions

As used herein, the term “diacid’ or “dicarboxylic acid” refers to aliphatic, cycloaliphatic, and aromatic dicarboxylic acids. In one embodiment, dicarboxylic acid(s) are chosen from aliphatic dicarboxylic acids having 3 to 36 carbon atoms, cycloaliphatic dicarboxylic acids having 8 to 14 carbon atoms and aromatic dicarboxylic acids having 8 to 16 carbon atoms. Exemplary dicarboxylic acids include oxalic acid; malonic acid; succinic acid; glutaric acid, adipic acid, pimelic acid, azelaic acid, sebacic acid, decanedioic acid, dodecanedioic acid, glycolic acid, 1,2-cyclohexane dicarboxylic acid, 1,3-cyclohexane dicarboxylic acid, 1,4-cyclohexane dicarboxylic acid, biphenyl dicarboxylic acid, phthalic acid, isophthalic acid, terephthalic acid, octadecanedioic acid, and 2,6-naphthalene dicarboxylic acid. As this term denotes the dicarboxylic acid residue in the polyesteramide, the term “dicarboxylic acid” also includes the corresponding esters, acid anhydrides, and acid chlorides.

In one embodiment, the diacids include longer carbon chain species generally referred to as “dimer acids”, such as those available commercially from Croda under the Pripol™ trademark and utilizing the product designations 1010, 1006F, 1009F, 1010F, 1009, and 1012. Exemplary dimer acids include the following: 9-[(Z)-non-3-enyl]-10-octylnonadecanedioic acid; and 9-nonyl-10-octylnonadecanedioic acid (a hydrogenated dimer acid, Pripo/™ 1009). The dimer acid is assigned CAS No. 61788-89-4 and the hydrogenated version is assigned CAS No. 68783-41-5.

In general, dimer acids are obtained from the Diels-Alder synthetic reaction applied to unsaturated fatty acids, primarily from the starting materials of tall oil, oleic acid, canola, and cottonseed oil. A commercial product with 36 carbon atoms (C36) is obtained from unsaturated C18 acids that are often a component of tall oil with the structure of the resulting dimer acid shown in the figure below. Various grades are available, such as Unidyme™ from Kraton where distillation may be used to increase the dimer content as compared to monomeric and trimeric species. Hydrogenated grades are also available where the color is reduced and the residual double bonds are removed. Although C36 is most common other chain lengths are known commercially, such as the C44 offered under the trade name of Radiacid™ 0994 from Oleon.

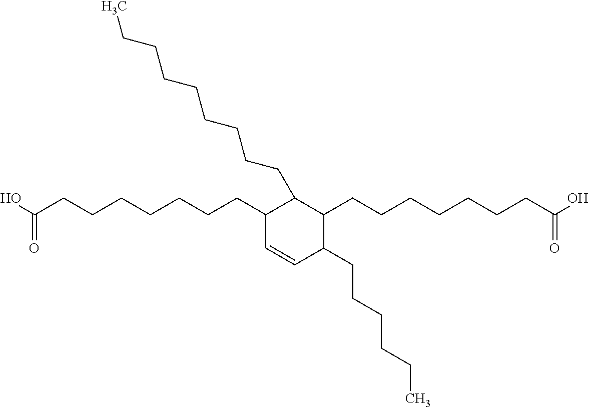 [SMILES: CCCCCCCCCC1C(CCCCCCCC(=O)O)C=CC(CCCCCC)C1CCCCCCCC(=O)O]

In another embodiment, the term “diacid” or “dicarboxylic acid(s)” may include (i) an additional heteroatom, beyond the oxygen atoms comprising the carboxyl moiety, such as sulfur, or (ii) one or more olefinic moieties. Exemplary compounds within this embodiment include t-butyl isophthalic acid, 5-hydroxy isophthalic acid, fumaric acid, maleic acid, itaconic acid, and 4,4′-sulfonyl dibenzoic acid. In certain embodiments, the diacids or dicarboxylic acids do not contain unsaturated or olefinic bonds.

As used herein, the term “glycol” refers to aliphatic, alicyclic, and aralkyl glycols. Exemplary glycols include ethylene glycol, 1,2-propandiol (also known propylene glycol), 1,3-propanediol, 1,4-butanediol, 1,5-pentanediol, 1,6-hexanediol, 2,2-dimethyl-1,3-propanediol, 1,2-cyclohexane dimethanol, 1,3-cyclohexane dimethanol, 1,4-cyclohexane dimethanol, 2,2,4,4-tetramethyl-1,3-cyclobutanediol, isosorbide, p-xylylenediol, and the like. These glycols may also contain ether linkages, such as is the case in, for example, diethylene glycol, triethylene glycol, and tetraethylene glycol. Additional embodiments of glycols include higher molecular weight homologs, known as polyethylene glycols, such as those produced by Dow Chemical Company under the Carbowax™ tradename. In one embodiment, the polyethylene glycol has a molecular weight of from greater than 200 to about 10,000 Daltons (Mn). These glycols also include higher order alkyl analogs, such as dipropylene glycol, dibutylene glycol, and the like. Similarly, further glycols include higher order polyalkylene ether diols, such as polypropylene glycol and polytetramethylene glycol with molecular weights ranging from about 200 to about 10,000 Daltons (Mn) (also referred to as g/mole).

As used herein the term “diamine” refers to alkylene, cycloalkylene, arylalkylene, or arylene diamines. In one embodiment, these diamines include alkylenediamines having 2 to 12 carbon atoms, cycloalkylenediamines having 6 to 17 carbon atoms, and aromatic diamines containing 8 to 16 carbon atoms. Exemplary diamines include 1,2-ethylenediamine, 1,6-hexamethylenediamine, 1,4 and 1,3-cyclohexanediamine, 1,4 and 1,3-cyclohexane bismethylamine, 4,4′-methylenebis(cyclohexylamine), 4,4′-methylenebis(2-methylcyclohexylamine), and 2,2,4,4-tetramethyl-1,3-cyclobutanediamine, 2,2,4-trimethylhexamethylenediamine, 4-oxaheptane-1,4-diamine, 4,7-dioxadecane-1,10-diamine, 1,4-cyclohexanebismethylamine, 1,3-cyclohexanebismethylamine, 1,7-heptamethylenediamine, 1,12-dodecamethylenediamine, and the like.

As used herein, the term “multifunctional reactant having at least three functional groups” refers to multifunctional compounds with at least three functional groups which result in branching within the polyesteramide structure. These branching agent compounds, in relatively small amounts, were found to facilitate molecular weight build up kinetics in the practice of this invention. In one embodiment, such multifunctional reactant(s) will be utilized in levels below or equal to about 1.0 mole percent. Exemplary multifunctional reactants include trimellitic acid, trimellitic anhydride, pyromellitic acid, pyromellitic dianhydride, trimesic acid, pentaerythritol, glycerol, trimethylolpropane (TMP), trimethylolethane (TME), erythritol, threitol, dipentaerythritol, sorbitol, dimethylolpropionic acid, and the like. In one embodiment, the multifunctional reactant is trimethylolpropane.

“Chain extenders” as used herein are chosen from compounds capable of reacting with one or more available end groups found in the polyesteramide, specifically carboxyl, hydroxyl, and amino groups. In certain embodiments, the polydispersity (Mw/Mn) of the polyesteramide obtained using the chain extender is less than about 6, less than about 5, or less than about 4. Exemplary chain extender classes include diepoxides, diisocyanates, biscaprolactams, bisoxazolines, carbodiimides, and dianhydrides. In another embodiment, the chain extenders have three or more groups chosen from carboxyl, hydroxyl, and amino groups (i.e., multifunctional). The intended function of the chain extenders can be carried out (i) during the polyesteramide synthesis process or (ii) at the end of the polyesteramide synthesis process, or (iii) via melt-mixing techniques and equipment such as a LIST kneader, a Brabender mixer, or a single- or double-screw extruder.

As used herein, the term “residue(s)” refers to the monomer unit or repeating unit in a polymer, oligomer, or dimer. For example, a polymer can be made from the condensation of the following monomers: terephthalic acid (“TPA”) and cyclohexyl-1,4-dimethanol (“CHDM”). The condensation reaction results in the loss of water molecules. The residues in the resulting polymer are derived from either terephthalic acid or cyclohexyl-1,4-dimethanol.

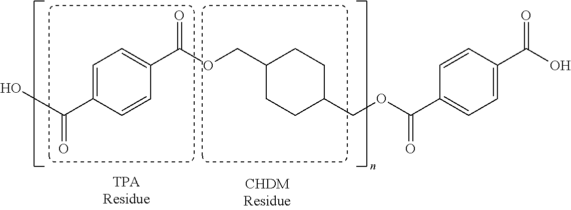

The polymer can also be functionalized by other reactants (e.g., epoxides, isocyanates, and the like) during and after the polymerization reaction. The incorporated reactants are also considered residues.

As used herein, the term “alkyl” shall denote a hydrocarbon substituent. Alkyl groups suitable for use herein can be straight, branched, or cyclic, and can be saturated or unsaturated. The carbon units in the alkyl group is often included; for example C₁-C₆ alkyl. Alkyl groups suitable for use herein include any C₁-C₂₀, C₁-C₁₂, C₁-C₅, or C₁-C₃ alkyl groups. Specific examples of suitable alkyl groups include, but are not limited to, methyl, ethyl, n-propyl, isopropyl, n-butyl, isobutyl, sec-butyl, tert-butyl, pentyl, hexyl, octyl, decyl, and dodecyl groups. As used herein, the term “alkylene” shall mean a bivalent alkyl radical, for example —CH₂— (methylene).

“Cycloalkyl” means a cyclic alkyl group having at least three carbon units, for example C₃-C₈ cycloalkyl. The number of carbon units in the cycloalkyl group is often included. Nonlimiting examples of cycloalkyl groups include cyclopropyl, cyclobutyl, cyclohexyl, cycloheptyl, and the like.

“Bicycloalkyl” means a ring system with two cycloalkyl rings. The bicycloalkyl ring system may be bridged or unbridged. The number of carbon units may be specified (e.g., C₆-C₁₇).

“Heterocyclyl” means a ring system containing one or more heteroatoms such as N, O, and S. The number and kind of heteroatoms present may be specified. The size of the ring may also be specified. An example includes a 6- to 8-membered heterocyclyl containing 2 N heteroatoms.

Examples of heterocyclyl groups include piperidinyl, piperazinyl, and pyrrolidine.

“Amorphous” means that the material will not exhibit a melting point by dynamic scanning calorimetry (“DSC”) after a scanning sequence consisting of cooling from the melt state (i.e., generally in the area of 280 to 300° C.) and heating under typical ramp (both cooling and heating) rates of 20° C./minute under a nitrogen atmosphere with the temperature range covered by the scans being from −50° C. to 300° C.

“Semi-crystalline” means that the material exhibits a melting point as detectable by DSC after a scanning sequence consisting of cooling from the melt state (i.e., generally in the area of 280 to 300° C.) and heating under typical ramp (both cooling and heating) rates of 20° C./minute under a nitrogen atmosphere with the temperature range covered by the scans being from −50° C. to 300° C.

As used herein, the term “parts per hundred resin” or “phr” refers to the amount of plasticizer present per one hundred parts of resin, on a weight basis. For example, if 30 grams of plasticizer were added to 100 grams of a resin, the plasticizer content would be 30 phr. If the polymer layer includes two or more resins, the weight of plasticizer is compared to the combined amount of all resins present to determine the parts per hundred resin. Further, when the plasticizer content of a layer or interlayer is provided herein, it is provided with reference to the amount of plasticizer in the mix or melt that was used to produce the layer or interlayer, unless otherwise specified.

Alkanedioic acids such as heptanedioic acid, octanedioic acid, nonanedioic acid, decanedioic acid, undecanedioic acid, dodecanedioic acid, tridecanedioic acid, hexadecanedioic acid, octadecanedioic acid, or eicosanedioic acid, can have terminal carboxylic acids or internal carboxylic acids. For example, heptane dioic acid can be 1,7 heptane dioic acid, 1,6-heptane dioic acid, 1,5-heptane dioic acid, 1,4-heptane dioic acid, 2,6-heptane dioic acid, 3,5-heptane dioic acid, and the like. The alkane group can be unbranched or branched. For example, heptane dioic acid can be 2-methylhexanedioic acid, 3-methylhexanedioic acid, 2-ethylpendanedioic acid, and the like.

One class (A) of carbonyl bislactams as referred to herein have the following formula:

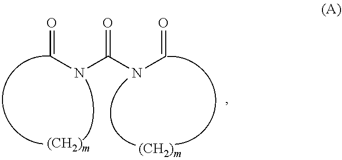

wherein m is an integer of from 3 to 15. In certain embodiments, m is from 5 to 12.

Another class (B) of biscaprolactams referred to herein has the following formula:

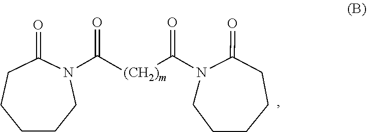

wherein m is from 2 to 20.

Another class (C) of biscaprolactams referred to herein have the following formula, in which the divalent linker group is either (i) a cycloaliphatic ring of from 3 to 20, or 5 to 12, or (ii) an aromatic ring chosen from phenylene and naphthalene:

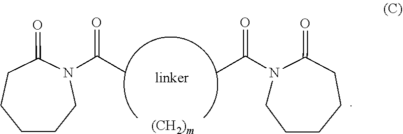

In one embodiment, the divalent linker group is 1,4-phenylene as shown below in an example of class (C):

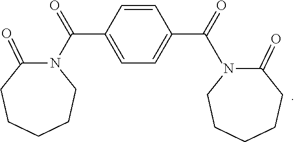

In certain embodiments, the diepoxides referred to above have the following general formula (D):

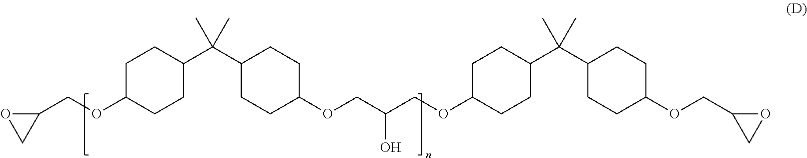

wherein n is from 0 to 100.

One example of a compound of formula (D) is EPONEX™ 1510 resin, available from Hexion (where n=0).

Compounds of formula (D) can be obtained, for example, from the reaction product of bisphenol A and epichlorohydrin, followed by hydrogenation.

In general, diglycidyl ethers of known bisphenols can be similarly utilized to synthesize other compounds of formula (A).

In one embodiment, aromatic epoxides may be utilized but are less desired for certain applications where UV resistance is needed.

Diepoxides as referred to herein also include other known epoxides such as:

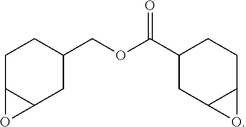 [SMILES: O=C(OCC1CCC2OC2C1)C1CCC2OC2C1]

Bis-oxazolines, as referred to herein, have the following general formulae:

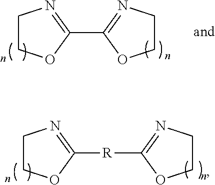

wherein n is 1 or 2, R is a divalent C₂-C₂₀ alkyl group, a C₅-C₁₂ cycloaliphatic group, or a group of the formulae:

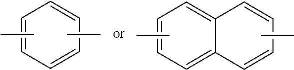

or (i.e., phenylene or naphthalene).

In a first aspect, the invention provides a polyesteramide composition comprising residues of:
a. at least one diacid;
b. about 10 to about 90 mole percent of at least one glycol;
c. about 10 to about 90 mole percent of at least one diamine; and optionally
d. a multifunctional compound having at least three functional groups chosen from carboxylic acid, amine, and hydroxyl groups;
wherein the sum of diacid equivalents is about 100 mole percent and the sum of diol and diamine equivalents is about 100 mole percent; and
e. about 0.01 to about 10 weight percent, based on the total weight of the polyesteramide comprised of a., b., c., and optionally d., of a chain extender reactive with groups chosen from carboxyl, amino, and hydroxyl groups, wherein said polyesteramide exhibits an inherent viscosity of about 0.6 to about 2.0 dL/g.

In certain embodiments, the polyesteramide composition will exhibit an inherent viscosity of about 0.6 to about 1.8, about 0.6 to about 1.6, about 0.6 to about 1.4, about 0.6 to about 1.2, about 0.6 to about 1.0, about 0.6 to about 0.8, about 0.8 to about 1.0, about 0.8 to about 1.2, about 0.8 to about 1.4, about 0.8 to about 1.6, about 0.8 to about 1.8, about 0.8 to about 2.0, about 1.0 to about 1.2, about 1.0 to about 1.4, about 1.0 to about 1.6, about 1.0 to about 1.8, about 1.0 to about 2.0, about 1.2 to about 1.4, about 1.2 to about 1.6, about 1.2 to about 1.8, about 1.2 to about 2.0, about 1.4 to about 1.6, about 1.4 to about 1.8, about 1.4 to about 2.0, about 1.6 to about 1.8, about 1.6 to about 2.0, or about 1.8 to about 2.0 dL/g.

In certain embodiments, the polyesteramides will have a number average molecular weight (Mn) of greater than about 10,000, greater than about 20,000, greater than about 30,000, or greater than about 40,000. In certain embodiments, the Mn will be less than about 100,000, less than about 90,000, less than about 80,000, less than about 70,000, less than about 60,000, or less than about 50,000 Daltons.

In one embodiment, the diacid is chosen from aliphatic dicarboxylic acids having 3 to 20 carbon atoms, cycloaliphatic dicarboxylic acids having 8 to 14 carbon atoms and aromatic dicarboxylic acids having 8 to 16 carbon atoms.

In one embodiment, the diacid is chosen from oxalic acid, malonic acid, succinic acid, glutaric acid, adipic acid, pimelic acid, azelaic acid, sebacic acid, decanedioic acid, dodecanedioic acid, glycolic acid, 1,2-cyclohexane dicarboxylic acid, 1,3-cyclohexane dicarboxylic acid, 1,4-cyclohexane dicarboxylic acid, phthalic acid, isophthalic acid, terephthalic acid, and 2,6-naphthalene dicarboxylic acid.

In one embodiment, the diacid is chosen from 9-[(Z)-non-3-enyl]-10-octylnonadecanedioic acid; and 9-nonyl-10-octylnonadecanedioic acid.

In one embodiment, the glycol is chosen from aliphatic, alicyclic, and aralkyl glycols.

In one embodiment, the glycol is chosen from ethylene glycol; 1,2-propandiol; 1,3-propanediol; 1,4-butanediol; 1,5-pentanediol; 1,6-hexanediol; 2,2-dimethyl-1,3-propanediol; 1,2-cyclohexane dimethanol; 1,3-cyclohexane dimethanol; 1,4-cyclohexane dimethanol; 2,2,4,4-tetramethyl-1,3-cyclobutanediol; isosorbide; p-xylylenediol; diethylene glycol; triethylene glycol; tetraethylene glycol; polyethylene glycols; dipropylene glycol; dibutylene glycol; polyalkylene ether diols chosen from polypropylene glycol and polytetramethylene glycol.

In one embodiment, the diamine is chosen from alkylenediamines having 2 to 12 carbon atoms, cycloalkylenediamines having 6 to 17 carbon atoms, and aromatic diamines containing 8 to 16 carbon atoms.

In one embodiment, the multifunctional reactant is present and is chosen from trimellitic acid, trimellitic anhydride, trimesic acid, pyromellitic acid, pyromellitic dianhydride, pentaerythritol, glycerol, trimethylolpropane, trimethylolethane, erythritol, threitol, dipentaerythritol, sorbitol, and dimethylolpropionic acid.

In one embodiment, the chain extender is chosen from difunctional compounds chosen from diepoxides, diisocyanates, biscaprolactams, bisoxazolines, carbodiimides, and dianhydrides.

In certain embodiments, the polyesteramide composition exhibits one or more of the following characteristics: (i) a glass transition temperature of about 0° C. to about 200° C.; (ii) less than about 2% haze; and/or an (iii) impact resistance of at least about 12 feet, as characterized by the mean break height of the interlayer, when having a thickness of between 30 and 60 mils and when laminated between two sheets of 2.3-mm thick clear glass, measured according to ANSI/SAE Z26.1-1996 at a temperature of about 70° F. (about 21° C.). Mean break height can also be measured at other thicknesses.

In another aspect, the invention provides a polyesteramide composition comprising residues of:
a. a diacid chosen from sebacic acid and dodecanedioic acid;
b. about 40 to about 60 mole percent of 1,4-cyclohexanedimethanol;
c. about 40 to about 60 mole percent of 4,4′-methylenebis(2-methylcyclohexylamine); and
d. about 0.1 to about 0.5 mole percent of trimethylolpropane; wherein the sum of diacid equivalents is about 100 mole percent and the sum of diol and diamine equivalents is about 100 mole percent; and
   about 0.01 to about 10 weight percent, based on the total weight of the polyesteramide comprised of a., b., c., and optionally d., of a chain extender reactive with groups chosen from carboxyl, amino, and hydroxyl groups.

The polyesteramides of the invention may be prepared by using a combination of methods which are known in the art for both polyesters and polyamides. In one aspect, the process involves two distinct stages: (a) a combined esterification and amidation stage followed by (b) a polycondensation stage.

Esterification and amidation reactions are advantageously conducted under an inert atmosphere (e.g., N2) at a temperature of 150 to 280° C. for 0.5 to 8 hours, or from 180 to 250° C. for 1 to 4 hours at atmospheric or greater pressure. The diols and diamines, depending on their reactivities and specific process conditions employed, are typically used in molar excesses of 1.0 to 4 moles per total moles of diacids monomers. Non-volatile glycols and diamines are advantageously added near stoichiometric balance to achieve high molecular weight, while volatile glycols and diamines are vaporized to some degree, particularly during the vacuum stage and are often added in stoichiometric excess.

The second stage, polycondensation, is generally conducted under reduced pressure, at a temperature of about 220° C. to about 350° C., or about 230° C. to 300° C., or about 240° C. to 290° C. for 0.1 to 6 hours or 0.25 to 4 hours. Stirring or other appropriate mixing conditions are advantageously used in both stages to ensure adequate heat transfer, mass transport, and surface renewal of the reaction mixture.

Other process variations which may be utilized are based on known polyester and polyamide synthetic methodologies. For example, the diamine(s) and diacid(s) may be first combined in the presence of water to form a salt. This is the process typically employed for polyamide synthesis to ensure balanced stoichiometry. For polyesteramides with less than 50 mole % diamine, a carboxyl-terminated prepolymer is obtained where glycol(s) may be added before the polycondensation stage is conducted under vacuum to achieve high molecular weight. In a similar fashion it is also possible to pre-react the glycol(s) and then add the diamine(s) in a separate stage.

The reactions of both stages are facilitated by appropriate catalysts, especially those known in the art and taught, for example, in U.S. Pat. Nos. 4,167,395 and 5,290,631, incorporated herein by reference. Exemplary catalysts include alkoxy, alkyl and halo titanates; alkali metal hydroxides and alcoholates; salts of organic carboxylic acids; alkyl tin compounds; metal oxides, such as antimony(III)oxide and germanium(IV)oxide; metal acetates, such as zinc acetate and aluminum acetate; and so forth. In some instances, the esterification stage may be autocatalytic when starting materials like terephthalic acid and isophthalic acid are used. A three-stage manufacturing procedure, similar to the disclosure of U.S. Pat. No. 5,290,631, incorporated herein by reference, may be used, particularly when a mixed monomer feed of acids and esters is employed.

a. Chain Extension

To achieve high molecular weights, where the inherent viscosity (IhV) is greater than about 0.8 dL/g, there must be few end groups remaining and stoichiometric imbalance between the carboxylic acid and amine+glycol ends will limit the ultimate molecular weight as shown by the Carother's equation:

$${DP}_{n} = \frac{1}{1 - p}$$

where DP is the degree of polymerization or number of repeat units on average in a polymer chain and p=conversion for a condensation polymer in stoichiometric balance. When stoichiometry is imbalanced the equation is modified to the form of:

$${DP}_{n} = \frac{1 + S}{1 + S - 2 Sp}$$

where S=the stoichiometric imbalance (e.g., S=0.98, if 0.98 mols of diacid are combined with 1.0 total moles of diamine+glycol). The effect is significant where a balanced stoichiometry at 99% conversion will yield a DP of 100 in comparison to only a 2% excess of diamine+glycol (S=0.98) that lowers the DP to 50. In embodiments, the DP of the polyesteramides are greater than about 50, greater than about 60, or greater than about 70.

It can be particularly advantageous in this chain extension methodology when all components are considered non-volatile as careful weighing to control the amount of each monomer charged is offset by small losses due to degradation, purity, and carryover with the removal of water. In this case the available acid ends have to react with the available hydroxyl or amino ends. Hydroxyl ends do not substantially react under the recited process conditions with other hydroxyl ends or amino ends and carboxyl ends do not react with other carboxyl ends. Advantageously, a preferred compound will have the ability to react with two or even all three of the substantially available functional groups. More than one chain extender compound having different functional group reactivities may also be utilized.

The chain extender is generally added after the polycondensation has achieved high conversion, although it is not necessary to wait until the rate of molecular weight increase has reached a plateau. Adding the chain extender earlier can shorten the overall process time. Best results are obtained when the chain extender is miscible with the polyesteramide upon addition as either a liquid or solid. Liquid chain extenders may be pre-heated to lower the viscosity and facilitate transfer. Solids can also be added as such, melted, or pre-dissolved in a suitable organic solvent. In this regard, exemplary solvents include toluene, isomers of xylene, heptane, tetrahydrofuran, glyme, diglyme, dodecane, Isopar™ isoparaffinic solvents, and other known solvents which do not have functional groups which react with ester or amide linkages. Thus, alcohols are less preferred, although not excluded, because alcohols can react with ester and amide linkages leading to molecular weight decrease. Water is not preferred, although not excluded, as it generally results in some amount of hydrolysis of the available ester and amide linkages.

b. Inherent Viscosity

Inherent viscosity (IhV) for these polyesteramides is a useful proxy for molecular weight and is determined according to the ASTM D2857-70 procedure, in a Wagner Viscometer of Lab Glass, Inc., having a ½ mL capillary bulb, using a polymer concentration about 0.5% by weight in 60/40 by weight of phenol/tetrachloroethane. The procedure is carried out by heating the polymer/solvent system at 120° C. for 15 minutes, cooling the solution to 25° C. and measuring the time of flow at 25° C. The inherent viscosity is calculated from the equation:

$${η}_{inh} = \frac{ln \frac{{t}_{S}}{{t}_{0}}}{C}$$

where:
η: inherent viscosity at 25° C. at a polymer concentration of 0.5 g/100 mL of solvent;
tₛ: sample flow time;
t₀: solvent-blank flow time;
C: concentration of polymer in grams per 100 mL of solvent (0.5)
(The units of the inherent viscosity throughout this application are expressed in deciliters/gram.)

In some embodiments, during the process for making the polyesteramides useful in the present invention, certain agents which colorize the polymer can be added to the melt including toners or dyes. In one embodiment, a bluing toner is added to the melt in order to adjust the b* of the resulting polymer melt phase product. Such bluing agents include blue inorganic and organic toner(s) and/or dyes. In addition, red toner(s) and/or dyes can also be used to adjust the a* color. In one embodiment, the polymers or polymer blends useful in the invention and/or the polymer compositions of the invention, with or without toners, can have color values L*, a* and b* which can be determined using a Hunter Lab Ultrascan Spectra Colorimeter manufactured by Hunter Associates Lab Inc., Reston, Va. The color determinations are averages of values measured on either pellets or powders of the polymers or plaques or other items injection molded or extruded from them, or interlayers laminated with glass. They are determined by the L*a*b* color system of the CIE (International Commission on IIIumination) (translated), wherein L* represents the lightness coordinate, a* represents the red/green coordinate, and b* represents the yellow/blue coordinate. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyesteramide's raw materials, for example, a glycol.

The total amount of toner components added can depend on the amount of inherent yellow color in the base polyesteramide and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Advantageously, the toner(s) are added to early stages of polymerization.

The polyesteramides of the invention may be combined or compounded with various additives. The polyesteramide compositions can further comprise additives known to one skilled in the art. In one embodiment, the compositions further comprise an additive chosen from antioxidants, adhesion promotion agents, adhesion control agents, colorants, mold release agents, flame retardants, plasticizers, nucleating agents, UV stabilizers, UV absorbers, thermal stabilizers, glass fibers, carbon fibers, fillers, impact modifiers, and silanes (such as an epoxy silane or isocyanate silane). In other embodiments, the composition comprises more than one additive. In certain embodiments, such additives may be present in amounts of from about 0.01 to about 25% by weight of the overall composition. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyesteramide composition. Examples of commercially available impact modifiers are well known in the art and useful in this invention include, but are not limited to, ethylene-co-glycidyl methacrylate-based impact modifiers, ethylene/propylene terpolymers based impact modifiers, styrene-based block copolymeric impact modifiers, and various acrylic core/shell type impact modifiers.

Thermal stabilizers which may be effective in stabilizing polyesteramides during melt processing including but not limited to phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl. The number of ester groups present in the particular phosphorus compound can vary from zero up to the maximum allowable based on the number of hydroxyl groups present on the phosphorus compound used.

Examples of thermal stabilizers include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, Additionally, phosphate esters may be utilized, such as dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine.

Reinforcing materials may also be utilized in the polyesteramide compositions of the invention. The reinforcing materials may include carbon filaments, silicates, mica, clay, talc, titanium dioxide, calcium carbonate, Wollastonite, glass flakes, glass beads and fibers, and polymeric fibers and combinations thereof.

In another embodiment, the polyesteramides of the invention may be combined with other thermoplastic polymers to provide a blend in order to enhance or diminish one particular performance characteristic or another. Accordingly, in another embodiment, the polyesteramide composition of the invention further comprises a polymer chosen from
(i) a polyesteramide other than those disclosed herein or having a different diol, diamine and/or diacid, or
(ii) a polymer chosen from one or more of a cellulose ester, a polyvinyl chloride, a polyvinyl alcohol, a polyvinyl acetate, a poly(vinyl butyral), a polyester, a polyamide, a polystyrene, a polystyrene copolymer, a styrene acrylonitrile copolymer, an acrylonitrile butadiene styrene copolymer, a poly(methylmethacrylate), an acrylic copolymer, a poly(ether-imide), a polyphenylene oxide, a polyphenylene sulfide, a polysulfone, a polysulfone ether, or a poly(ether-ketone) an ethylene vinyl acetate, a thermoplastic polyurethane, a polycarbonate, and ionomeric polymers such as those sold under the Surlyn™ product line (DuPont).

In one embodiment, the polyesteramide is present from about 1 to about 99 wt. % based on the total weight of the blend composition, and the polymer (other than polyesteramide) is present from about 1 to about 99 wt. % based the total weight of the blend composition. In one embodiment, the polyesteramide of the invention is present from about 5 to about 95 wt. % based on the total weight of the composition; and the other polymer is present from about 5 to about 95 wt. % based the total weight of the composition, although other amounts may be used depending on the desired properties.

In the following examples, a viscosity was measured in tetrachloroethane/phenol (60/40, weight ratio) at 25° C., and calculated in accordance with the following equation:

$${η}_{inh} = \frac{ln ( {η}_{sp} )}{C}$$

wherein ηₛₚ is a specific viscosity and C is a concentration. The units of inherent viscosity are deciliters/g.

As noted above, the inherent viscosity of the polyesteramides of the invention is at least about 0.6 dl/g. In certain embodiments, the inherent viscosity is at least about 0.8 dl/g, in other embodiments, the inherent viscosity is at least about 1.0 dl/g, in other embodiments, at least about 1.2 dl/g, and in further embodiments, at least about 1.3 dl/g. In other embodiments, the inherent viscosity is less than or equal to about 2.0 dl/g. Also, as noted above, inherent viscosity is described herein and used as a proxy for the molecular weight of the polyesteramide. This inherent viscosity parameter/molecular weight (Mn) is very important for the desired end-use properties and applications. Further, in the polyesteramide compositions and blend compositions, two further important properties are impact performance and 24° C. one-month relaxation modulus, as further described below.

In a second aspect, the invention provides shaped or formed articles comprising the polyesteramide compositions as set forth herein. Such articles present a wide variety of potential end-uses, consistent with the end-uses currently existing for thermoplastic resins having similar physical properties. Advantageously, the polyesteramides of the invention are capable of being autoclaved. Accordingly, in another aspect, the invention provides a shaped or formed article of manufacture. Exemplary articles include a film, a sheet, a container, packaging material, battery housing, medical device housing, medical device tubing, industrial articles and connectors, and the like.

In a third aspect, the invention provides layers, interlayers, sheets or films, comprising the polyesteramides or polyesteramide compositions disclosed herein. In certain embodiments, the polyesteramide may be amorphous, while in other embodiments the polyesteramide may be semi-crystalline. The methods of forming the layers, interlayers, sheets or films comprising the polyesteramides or compositions referred to herein are well known in the art. Such layers, interlayers, sheets or films may thus be produced from the polyesteramides or polyesteramide compositions according to various embodiments of the present invention using any suitable method and include but not limited to extrusion, co-extrusion, calendaring, compression molding, injection molding, and solution casting.

As used herein, the term “film” generally refers to thin films. In certain embodiments, such thin films are capable of being rolled, whereas a sheet refers to an article which is too thick to be rolled. In certain embodiments, films of the invention are about 20 microns to about 400 microns, or about 20 to about 80 microns, or about 40 to about 250 microns thick. In certain embodiments, sheets of the invention are greater than about 400 microns, for example, about 1250 microns to about 0.75 inches in thickness.

As used herein, the term “interlayer” refers to a single layer or multiple layer polymer sheet suitable for use in forming a multiple layer panel. Multiple layer panels are typically formed by sandwiching the interlayer between two substrates, which can be formed from a rigid material such as glass, and laminating the assembly to form a multiple layer laminated panel. Multiple layer panels may be formed using a single layer or multiple layer interlayer. As used herein, the terms “layer”, “single layer” and “monolithic” refer to interlayers formed of one single polymer layer, while the terms “multiple layer” or “multilayer” refer to interlayers having two or more polymer layers adjacent to and in contact with one another. As used herein, “layer” and “interlayer” may be used interchangeably. Each polymer layer of an interlayer may include one or more polymeric resins, optionally combined with one or more plasticizers (depending on the type of polymeric resin(s) and desired properties), which have been formed into a sheet. One or more of the polymer layers may further include additional additives, although these are not required. For multilayer interlayers, and particularly for multiple layers of different polymers or materials, the layers may be treated to improve interfacial adhesion, or an additive, such as a silane-containing agent, may be added to promote or improve the adhesion between layers. An adhesive layer or coating (such as a tie layer) may also be used between two polymer layers to improve adhesion between the layers, particularly layers of different polymers.

Accordingly, in another aspect, the invention provides a laminate structure, comprising:
a. a top panel layer;
b. a polyesteramide composition comprising residues of:
   i. at least one diacid;
   ii. about 10 to about 90 mole percent of a diol;
   iii. about 10 to about 90 mole percent of a diamine; and optionally
   iv. a multifunctional reactant having at least three functional groups chosen from carboxylic acid, amine, and hydroxyl groups;
      wherein the sum of diacid equivalents is about 100 mole percent and the sum of diol and diamine equivalents is about 100 mole percent; and
   v. about 0.01 to about 10 weight percent, based on the total weight of the polyesteramide composition comprised of i., ii., iii., and optionally iv., of a chain extender reactive with groups chosen from carboxyl, amino, and hydroxyl groups, wherein said polyesteramide exhibits an inherent viscosity of about 0.6 to about 2.0 dL/g; and
   c. a bottom panel layer.

The polymer compositions utilized in polymer interlayers as described herein may comprise one or more thermoplastic polymer resins, at least one of which is the polyesteramide composition of the invention. In some embodiments, the polyesteramide composition may be present in the polymer layer in an amount of at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, at least about 95, at least about 96, at least about 97, at least about 98, or at least about 99 weight percent or more based on the total weight of the polymer interlayer. When two or more resins are present, each may be present in an amount of at least about 0.5, at least about 1, at least about 2, at least about 5, at least about 10, at least about 15, at least about 20, at least about 25, at least about 30, at least about 35, at least about 40, at least about 45, or at least about 50 weight percent, based on the total weight of the polymer interlayer.

In certain embodiments, the polyesteramide interlayer has a glass transition temperature of about 0° C. to about 75° C. In certain embodiments, the glass transition temperature is about 67° C. to about 73° C., or 69° C. to 70° C., as measured by dynamic mechanical thermal analysis (DMTA), as discussed further below.

The polyesteramides of the invention may be used alone as interlayers or in combination with layers comprising other thermoplastic polymers. Examples of suitable thermoplastic polymers can include, but are not limited to, polyvinyl acetal polymers (PVA) (such as poly(vinyl butyral) (PVB) or poly(vinyl isobutyral), an isomer of poly(vinyl butyral) and also referred as PVB or PVisoB, aliphatic polyurethanes (PU), poly(ethylene-co-vinyl acetate) (EVA), poly(vinyl chlorides) (PVC), poly(vinylchloride-co-methacrylate), polyesters, polyamides, polycarbonates, poly(methyl methacrylates)(PMMA), polyethylenes, polyolefins, silicone elastomers, epoxy resins, ethylene acrylate ester copolymers, poly(ethylene-co-butyl acrylate), and acid copolymers such as ethylene/carboxylic acid copolymers and its ionomers, derived from any of the foregoing possible thermoplastic resins, combinations of the foregoing, and the like.

EVA polymers (or copolymers) can contain various amounts of vinyl acetate groups. The desirable vinyl acetate content is generally from about 10 to about 90 mol %. EVA with lower vinyl acetate content can be used for sound insulation at low temperatures. The ethylene/carboxylic acid copolymers are generally poly(ethylene-co-methacrylic acid) and poly(ethylene-co-acrylic acid) with the carboxylic acid content from 1 to 25 mole %. Ionomers of ethylene/carboxylic acid copolymers can be obtained by partially or fully neutralizing the copolymers with a base, such as the hydroxide of alkali (sodium for example) and alkaline metals (magnesium for example), ammonia, or other hydroxides of transition metals such as zinc. Examples of ionomers of that are suitable include Surlyn® ionomer resins (commercially available from DuPont, Wilmington, Del.). In some embodiments, the thermoplastic polymer can be chosen from poly(vinyl acetal) resins, poly(vinyl chloride), poly(ethylene-co-vinyl) acetates, and polyurethanes, while in other embodiments, the polymer can be comprised of one or more poly(vinyl acetal) resins. When an interlayer includes more than one polymer layer, each layer may include the same type of thermoplastic polymer resin, or one or more layers may include at least one different type of resin.

The layer or interlayer may also be used with other types of polymers or polymer layers, such as a cellulose ester, a polyvinyl chloride, a nylon, a polyester, a polyamide, a polystyrene, a polycarbonate, a polystyrene copolymer, a styrene acrylonitrile copolymer, an acrylonitrile butadiene styrene copolymer, a poly(methylmethacrylate), an acrylic copolymer, a poly(ethery-imide), a polyphenylene oxide, a polyphenylene sulfide, a polysulfone, a polysulfone ether, a polycarbonate, or a poly(ether-ketone) of an aromatic dihydroxy compound.

Thermoplastic polymer resins used in one or more layers (other than the polyesteramides of the invention) may be formed by any suitable method. In certain embodiments, when the thermoplastic polymer resins include poly(vinyl acetal) resins, such resins may be formed by acetalization of poly(vinyl alcohol) with one or more aldehydes in the presence of a catalyst according to known methods such as, for example, those described in U.S. Pat. Nos. 2,282,057 and 2,282,026, as well as Wade, B. (2016), “Vinyl Acetal Polymers”, Encyclopedia of Polymer Science and Technology, pp. 1-22 (John Wiley & Sons, Inc.), incorporated herein by reference. The resulting poly(vinyl acetal) resins may include at least about 50, at least about 60, at least about 70, at least about 75, at least about 80, at least about 85, or at least about 90 weight percent of residues of at least one aldehyde, measured according to ASTM 1396 as the percent acetalization of the resin. The total amount of aldehyde residues in a poly(vinyl acetal) resin can be collectively referred to as the acetal content, with the balance of the poly(vinyl acetal) resin being residual hydroxyl groups (as vinyl hydroxyl groups) and residual ester groups (as vinyl acetate groups), which will be discussed in further detail below.

Suitable poly(vinyl acetal) resins may include residues of any aldehyde and, in some embodiments, may include residues of at least one C₄ to C₈ aldehyde. Suitable C₄ to C₈ aldehydes can include, for example, n-butyraldehyde, i-butyraldehyde (also referred to as iso-butyraldehyde), 2-methylvaleraldehyde, n-hexyl aldehyde, 2-ethylhexyl aldehyde, n-octyl aldehyde, and combinations thereof. One or more of the poly(vinyl acetal) resins utilized in the layers and interlayers described herein can include at least about 20, at least about 30, at least about 40, at least about 50, at least about 60, or at least about 70 weight percent of residues of at least one C₄ to C₈ aldehyde, based on the total weight of aldehyde residues of the resin. Alternatively, or in addition, the poly(vinyl acetal) resin may include not more than about 99, not more than about 95, not more than about 90, not more than about 85, not more than about 80, not more than about 75, not more than about 70, or not more than about 65 weight percent of at least one C₄ to C₈ aldehyde. The C₄ to C₈ aldehyde may be chosen from the group listed above, or it can be chosen from n-butyraldehyde, i-butyraldehyde, 2-ethylhexyl aldehyde, and combinations thereof.

In various embodiments, the poly(vinyl acetal) resin may be a poly(vinyl butyral) (PVB) resin primarily derived from n-butyraldehyde, and may, for example, include not more than about 30, not more than about 20, not more than about 10, not more than about 5, not more than about 2, or not more than 1 weight percent of residues of an aldehyde other than n-butyraldehyde. Typically, the aldehyde residues other than n-butyraldehyde present in poly(vinyl butyral) resins may include iso-butyraldehyde, 2-ethylhexyl aldehyde, and combinations thereof. When the poly(vinyl acetal) resin comprises a poly(vinyl butyral) resin, the weight average molecular weight of the resin can be at least about 30,000, at least about 40,000, at least about 50,000, at least about 65,000, at least about 75,000, at least about 85,000, at least about 100,000, or at least about 125,000 Daltons and/or not more than about 500,000, not more than about 450,000, not more than about 300,000, not more than about 350,000, not more than about 300,000, not more than about 250,000, not more than about 200,000, not more than about 170,000, not more than about 160,000, not more than about 155,000, not more than about 150,000, not more than about 140,000, or not more than about 135,000 Daltons, measured by size exclusion chromatography using low angle laser light scattering (SEC/LALLS) method of Cotts and Ouano in tetrahydrofuran.

In general, poly(vinyl acetal) resins can be produced by hydrolyzing a poly(vinyl acetate) to poly(vinyl alcohol), and then acetalizing the poly(vinyl alcohol) with one or more of the above aldehydes to form a poly(vinyl acetal) resin. In the process of hydrolyzing the poly(vinyl acetate), not all the acetate groups are converted to hydroxyl groups, and, as a result, residual acetate groups remain on the resin. Similarly, in the process of acetalizing the poly(vinyl alcohol), not all of the hydroxyl groups are converted to acetal groups, which also leaves residual hydroxyl groups on the resin. As a result, most poly(vinyl acetal) resins include both residual hydroxyl groups (as vinyl hydroxyl groups) and residual acetate groups (as vinyl acetate groups) as part of the polymer chain. As used herein, the terms “residual hydroxyl content” and “residual acetate content” refer to the amount of hydroxyl and acetate groups, respectively, that remain on a resin after processing is complete. Both the residual hydroxyl content and the residual acetate content are expressed in weight percent, based on the weight of the polymer resin, and are measured according to ASTM D-1396.

One or more of the polymer interlayers may also include at least one plasticizer. When present, the plasticizer content of one or more polymer layers can be at least about 2, at least about 5, at least about 6, at least about 8, at least about 10, at least about 15, at least about 20, at least about 25, at least about 30, at least about 35, at least about 40, at least about 45, at least about 50, at least about 55, at least about 60, at least about 65, at least about 70, at least about 75, or at least about 80 parts per hundred resin (phr) and/or not more than about 120, not more than about 110, not more than about 105, not more than about 100, not more than about 95, not more than about 90, not more than about 85, not more than about 75, not more than about 70, not more than about 65, not more than about 60, not more than about 55, not more than about 50, not more than about 45, not more than about 40, or not more than about 35 phr. In some embodiments, one or more polymer layers can have a plasticizer content of less than 35, not more than about 32, not more than about 30, not more than about 27, not more than about 26, not more than about 25, not more than about 24, not more than about 23, not more than about 22, not more than about 21, not more than about 20, not more than about 19, not more than about 18, not more than about 17, not more than about 16, not more than about 15, not more than about 14, not more than about 13, not more than about 12, not more than about 11, or not more than about 10 phr.

Any suitable plasticizer can be used in the polymer layers described herein. The plasticizer may have a hydrocarbon segment of at least about 6 and/or not more than about 30, not more than about 25, not more than about 20, not more than about 15, not more than about 12, or not more than about 10 carbon atoms. Other examples of plasticizers can include phosphate esters, epoxidized oil, solid state plasticizers, fire retardant plasticizers, and combinations thereof.

Any of the additional polymer interlayers may also include other types of additives that can impart particular properties or features to the polymer layer or interlayer. Such additives can include, but are not limited to, adhesion control agents (“ACAs”), dyes, pigments, stabilizers such as ultraviolet stabilizers, antioxidants, anti-blocking agents, flame retardants, IR absorbers or blockers such as indium tin oxide, antimony tin oxide, lanthanum hexaboride (LaB6) and cesium tungsten oxide, processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, as well as any additives previously described. Specific types and amounts of such additives may be selected based on the final properties or end use of a particular layer or interlayer.

The glass transition temperature (T_{g}) of a polymeric material is the temperature that marks the transition of the material from a glass state to a rubbery state. The glass transition temperatures of the polymer layers can be determined by dynamic mechanical thermal analysis (DMTA) according to the following procedure: A polymer sheet is molded into a sample disc of 8 millimeters (mm) in diameter. The polymer sample disc is placed between two parallel plate test fixtures of a Rheometrics Dynamic Spectrometer II. The polymer sample disc is tested in shear mode at an oscillation frequency of 1 Hertz as the temperature of the sample is increased from 20° C. to 100° C. at a rate of 3° C./minute. The position of the maximum value of tan delta (damping) plotted as dependent on temperature is used to determine the glass transition temperature. Experience indicates that the method is reproducible to within +/−1° C. When a polymer layer or interlayer includes two or more polymer layers, at least one of the layers may have a glass transition temperature different from one or more other polymer layers within the interlayer.

In some embodiments, the interlayers described herein can include at least a first outer polymer layer and a second outer polymer layer. As used herein, the term “outer” refers to the outermost layer or layers of an interlayer. Typically, the outer polymer layers are configured to be in contact with a substrate when the interlayer is laminated to the substrate, or to one of a pair of substrates when the interlayer is used to form a multiple layer panel. In some embodiments, each of the first and second outer polymer layers can include respective first and second polyesteramides disclosed herein (and an optional plasticizer or other additives). In some embodiments, each of the first and second outer polymer layers can include a poly(vinyl acetal) resin and an optional plasticizer, and the resins may have residual hydroxyl contents and residual acetate contents within one or more of the ranges provided above. Similarly, each of the first and second polymer layers can include at least one plasticizer of a type and in the amounts described above, so that the layers may also have a glass transition temperature as previously described. In other embodiments, depending on the polymer(s) used in the layer(s), the outer layer(s) may also have an adhesive, coating, or tie layer to facilitate bonding to a substrate such as glass.

According to some embodiments, the first and second outer polymer layers may be adjacent to and in contact with one another, such that the first and second outer polymer layers are the only two layers of the interlayer. In other embodiments, at least 1, at least 2, at least 3, at least 4, or at least 5 or more polymer layers may be disposed between and in contact with at least one of the first and second outer polymer layers. These additional layers, when present, may have compositions similar to, or different than, each of the first and second polymer layers and may include one or more of the polymers described above. Further, as described above, the outer layer(s) may also have an adhesive, coating, tie layer or treatment to facilitate bonding to a rigid substrate such as glass.

One or more layers may also be formed of other materials, such as a polymer film formed from polyethylene terephthalate (PET), and the polymer film may include various metallic, metal oxide, or other non-metallic materials or layers and may be coated or otherwise surface-treated. In some embodiments, one or more of the additional layers may comprise functional layers such including, for example, IR reducing layers, holographic layers, photochromic layers, electrochromic layers, antilacerative layers, heat strips, antennas, solar radiation blocking layers, decorative layers, and the like.

In some embodiments, the interlayer can include at least a first polymer layer, a second polymer layer, and a third polymer layer, wherein the second polymer layer is disposed between and in contact with each of the first and third polymer layers. In certain embodiments, the first and third polymer layers can include at least one polyesteramide composition of the types and in the amounts described in detail previously, and the second (or middle) layer may include a different polyesteramide composition as previously described. In certain embodiments, the first and third polymer layers can include at least one polyesteramide composition of the types and in the amounts described in detail previously, and the second (or middle) layer may include a different polymer resin, such as a polycarbonate. In other embodiments, the first and third polymer layers can include at least one poly(vinyl acetal) resin and an optional plasticizer of the types and in the amounts described in detail previously, and the second (or middle) layer may include a polyesteramide layer as previously described. In still other embodiments, the first and third polymer layers can include at least polymer resin different from the polyesteramides disclosed herein (i.e., a non-polyesteramide), and the second (or middle) layer may include a polyesteramide layer as previously described. Depending on the desired properties, relatively “soft” (i.e., lower glass transition temperature) outer polymer layers can sandwich a “stiff” (i.e., relatively higher glass transition temperature) inner layer, which facilitates both enhanced rigidity and impact resistance in multiple layer panels formed from the interlayer. Alternatively, relatively “hard” (i.e., higher glass transition temperature) outer polymer layers can sandwich a “soft” (i.e., relatively lower glass transition temperature) inner layer. Additional layers may also be included.

When three or more layers are employed in the multilayered interlayers, some of the layers can be referred to as skin (or outer) layers and one or more may be referred to as core (or inner) layers. As used herein, “skin layer” generally refers to outer layers of the interlayer and “one or more core layers” generally refers to one or more of the inner layer(s) disposed between the skin layers. At least one side of a core layer can be in direct contact with at least one side of a skin layer or may be in indirect contact with a skin layer through a tie layer, a coating or adhesive agent.

Exemplary multilayer interlayer embodiments include, but are not limited to: non-polyesteramide//polyesteramide//non-polyesteramide; non-polyesteramide//polyesteramide; non-polyesteramide//polyesteramide//polyesteramide//non-polyesteramide; non-polyesteramide//polyesteramide//non-polyesteramide//polyesteramide//non-polyesteramide; non-polyesteramide//polyesteramide//polyesteramide//non-polyesteramide//non-polyesteramide; polyesteramide//non-polyesteramide//polyesteramide; polyesteramide//non-polyesteramide//non-polyesteramide//polyesteramide; polyesteramide//non-polyesteramide//polyesteramide//non-polyesteramide//polyesteramide; or polyesteramide//non-polyesteramide//non-polyesteramide//non-polyesteramide//polyesteramide.

In other embodiments, the multilayer structures may comprise 2 or more polyesteramide layers which are either the same or different, either compositionally or by glass transition temperature or both. For example, certain polyesteramide layers may have a relatively low glass transition temperature and other layers may have a relatively high glass transition temperature.

Exemplary multilayer structures may comprise a structure such as polyesteramide Tg¹//polyesteramide Tg²//polyesteramide Tg³, etc., wherein Tg¹, Tg², Tg³, . . . may each independently be chosen from relatively low, relatively high, and relatively intermediate Tg's.

In certain embodiments, −20° C.≤Tg¹, Tg², Tg³, . . . ≤200° C. Non-limiting examples include polyesteramide//high Tg polyesteramide//polyesteramide; and polyesteramide// low Tg polyesteramide//polyesteramide.

In each of these embodiments, the polyesteramide layers may comprise different polyesteramides based on composition. Thus, any combination of polyesteramide layer(s) with other polyesteramide layer(s) and/or non-polyesteramide layer(s) may be the same or different compositions. Other embodiments and permutations are possible, as would be recognized by one skilled in the art. The polyester and non-polyesteramide layer(s) may be any polymer layer previously described. Further, additional coatings or layers, such as an adhesive or tie layer, may be included in any embodiments as desired.

In other embodiments, the layer or interlayer is a monolithic interlayer. In certain embodiments, the interlayer comprises at least two layers. In other embodiments, the interlayer comprises at least three layers, wherein at least one layer comprises a polyesteramide as previously described. In other embodiments, the interlayer comprises at least three layers, wherein at least two layers comprise a polyesteramide as previously described. In other embodiments, the interlayer comprises more than three layers, wherein at least one layer comprises a polyesteramide as previously described.

Layers and interlayers according to various embodiments of the present invention may exhibit enhanced properties as compared to conventional interlayers. For example, in contrast to comparative interlayers used for architectural applications, interlayers as described herein may exhibit both high rigidity and good impact performance, while still retaining suitable or even excellent optical characteristics. As a result, interlayers as described herein may suitably be utilized in many structural and load-bearing applications, subject to various pressures, temperature changes, and impacts, while maintaining both suitable performance and aesthetic value and properties.

Interlayers as described herein may exhibit an enhanced rigidity. Rigidity of a polymer layer or interlayer may be characterized by its shear storage modulus (G′), measured at 50° C. (and, in some cases, at other temperatures, as described below) according to ASTM D4065-12. In some embodiments, a polymer layer or interlayer as described herein may have a shear storage modulus (G′) at 50° C. of at least about 4, at least about 5, at least about 10, at least about 20, at least about 30, at least about 40, at least about 50, at least about 60, at least about 70, at least about 80, at least about 90, at least about 100, at least about 110, at least about 120, at least about 130, at least about 140 MPa, at least about 150 MPa, at least about 160 MPa, at least about 170 MPa, at least about 180 MPa, at least about 190 MPa, at least about 200 MPa, at least about 210 MPa, or at least about 220 MPa. There is no particular upper limit, although practically, the layer or interlayer may exhibit a shear storage modulus as high as 250 MPa or even as high as 280 MPa or more at 50° C.

In addition to enhanced rigidity, interlayers according to embodiments of the present invention can exhibit desirable impact resistance, as characterized by the break height (or mean break height) of the interlayer, when having a thickness of 30 mils and when laminated between two sheets of 3-mm thick clear glass, measured according to ANSI/SAE Z26.1-1996 at a temperature of about 70° F. (about 21° C.). In some embodiments, the interlayers as described herein can have a break height, measured as described above, of at least about 12, at least about 12.5, at least about 13, at least about 13.5, at least about 14, at least about 14.5, at least about 15, at least about 15.5, at least about 16, at least about 16.5, at least about 17, at least about 17.5, at least about 18, at least about 18.5, at least about 19, at least about 19.5, at least about 20, at least about 20.5, at least about 21, at least about 21.5, at least about 22, at least about 22.5, at least about 23, at least about 23.5, at least about 24, at least about 24.5, or at least about 25 feet, at least about 25.5, at least about 26, at least about 26.5, at least about 27, at least about 27.5, at least about 28, or at least about 28.5 feet or more. Break height can also be measured at other thicknesses. In embodiments, the higher the break height, the better.

The values for break height (or mean break height) provided herein were obtained using an interlayer having a known thickness 0.762 mm (i.e., 30 mils or 30 gauge) laminated between two 3-mm thick sheets of glass. The specification of values for these parameters is not intended to, in any way, limit the thickness of the interlayers described herein or the configuration of multiple layer panels according to embodiments of the present invention. Rather, specification of values for these parameters is intended to provide a definite test for determining the impact resistance, measured as mean break height, exhibited by an interlayer, and the test is measured at a known thickness and if necessary, normalized to a constant thickness (such as 30 mils or 45 mils) so that different interlayers can be compared at the same interlayer thickness. In many of the examples herein, only one interlayer was tested due to material availability for a given composition, therefore the data provided is simply a break height rather than a mean break height.

Pummel adhesion is another parameter that may be used to describe the interlayers disclosed herein. The Pummel Adhesion Test measures the adhesion level of glass to the interlayer in a laminate construction. The interlayer to glass adhesion has a large effect on the impact resistance and long-term stability of glass-interlayer structures. In this test, the laminates are either cooled to 0° F. (−18° C.) or conditioned at room temperature of 70° F. (21° C.) and pummeled with the equivalent force of a 1 lb. (0.45 kg) hammer (i.e., with a hammer or with an automated instrument) on a steel plate at a 45° angle. The samples are then allowed to come to room temperature and all broken glass unadhered to the interlayer is then removed. The amount of glass left adhered to the interlayer is visually compared with a set of standards. The standards correspond to a scale in which varying degrees of glass remained adhered to the interlayer. For example, at a pummel standard of zero, essentially no glass is left adhered to the interlayer. On the other hand, at a pummel standard of ten, essentially 100 percent of the glass remains adhered to the interlayer. Pummel values are grouped and averaged for like specimens. Reported values state the average pummel value for the group and the maximum range of the pummel adhesion rating for individual surfaces. The interlayers described herein may have a pummel adhesion rating of 2 or greater, or 9 or less, or from about 2 to about 9.

In addition to enhanced rigidity and impact performance, interlayers according to embodiments of the present invention also exhibit suitable optical properties, which may vary depending on the ultimate end use. Clarity is one parameter used to describe the optical performance of the interlayers described herein and may be determined by measuring haze value or percent. Haze value represents the quantification of light scattered by a sample in contrast to the incident light. The test for determining haze value is performed with a hazemeter on a polymer sample which has been laminated between two sheets of clear glass, each having a thickness of 3 mm on a 30 gauge polymer sample (0.76 mm).

In certain embodiments, the layer or interlayer has a percent (%) haze (as measured in accordance with ASTM D1003-61 (reapproved 1977)—Procedure B using IIIuminant C, at an observer angle of 2 degrees on an interlayer having a thickness of 0.76 millimeters, laminated with 3 mm glass) of less than 5.0. When the interlayer is used in a multiple layer panel for which a high level of optical clarity is desired, such as, for example, in clear windows or windshields, the interlayer may be transparent or nearly transparent. In some embodiments, interlayers of the present invention may have a percent (%) haze value of less than about 5.0, less than 4.5, less than about 4.0, less than 3.5, less than 3.0, less than 2.5, less than 2.0, or less than 1.5, or less than 1.0, or less than 0.5 percent, as measured in accordance with ASTM D1003-61 (reapproved 1977)—Procedure B using IIIuminant C, at an observer angle of 2 degrees on an interlayer having a thickness of 0.76 millimeters and laminated with 3 mm glass. In other embodiments, when haze is less important (or when a more opaque interlayer is desired), the interlayer may have a higher haze value, such as, for example, at least about 25, at least about 30, or at least about 40 percent.

Yellowness Index (“YI”) is another measure of optical quality for laminate structures. Yellowness Index of a polymer sheet is measured by laminating (and autoclaving) a 30 gauge (30 mil or 0.76 mm) sheet sample between two pieces of 3 mm clear glass using the HunterLab UltraScan XE according to ASTM Method E313 (formerly D-1925) (illuminant C, 2° observer angle) from spectrophotometric light transmittance in the visible spectrum. In certain embodiments, the layer or interlayer has excellent color or yellowness index, YI, measured according to ASTM Method E313 (formerly D-1925) (illuminant C, 2° observer angle). In various embodiments, the interlayers can exhibit a yellowness index of less than 2.5, less than 2.0, less than 1.5, less than 1.0, less than 0.75, less than 0.5, less than 0.4, or less than 0.3 according to ASTM E313.

Another parameter used to determine the optical performance is percent visual transmittance (% Tvis), which is measured on the HunterLab UltraScan XE, commercially available from Hunter Associates (Reston, Va.). The values may be obtained by analyzing a 30 gauge polymer sample which has been laminated between two sheets of clear glass, each having a thickness of 3 mm (commercially available from Pittsburgh Glass Works of Pennsylvania). In some embodiments, when clear multiple layer panels are desired, the interlayers of the present invention can have a percent visual transmittance of at least about 80, at least about 81, at least about 82, at least about 83, at least about 84, at least about 85, at least about 85.5, at least about 86, at least about 86.5, at least about 87, at least about 87.5, or at least about 88, at least about 88.5 percent or higher.

In certain embodiments when the transparency and/or haze of the interlayer is not as important, the interlayer, or panel formed therefrom, may be translucent, at least partially opaque, or totally opaque. Examples of applications for such panels include privacy glass or other similar end uses. According to some embodiments, such an interlayer may have, for example, a haze value greater than about 30 percent. Alternatively, or in addition, the interlayer may have a visual transmittance of least about 2 percent, at least about 5 percent, at least about 10 percent and/or not more than about 40 percent, not more than about 35 percent, or not more than about 30 percent. Additionally, in some embodiments, the interlayers as described herein may have a reflectance (% R) greater than 5 percent, at least about 10 percent, or at least about 15 percent and/or not more than about 50, not more than about 45, or not more than about 40 percent, measured according to ASTM E-1164. Other values of reflectance, transmittance, and haze may also be possible, depending on the particular end use. Further, the levels of reflectance, transmittance, and haze may be controlled according to any suitable method including, for example, inclusion of additives, colorants, dyes, and other similar components.

To determine the 24° C. one-month shear storage modulus (G′), a frequency sweep and master curve is constructed. A frequency sweep is performed on a dynamic mechanical analysis (DMA) instrument according to the following procedure: A polymer sheet is molded into a sample disc of 8 millimeters (mm) in diameter. The polymer sample disc is placed between two parallel plate test fixtures of a Discovery HR-2 rheometer (TA Instruments). The polymer sample disc is tested in shear mode at a constant temperature, frequency range between 0.01 to 100 Hertz.

To construct a master curve to get shear storage modulus (G′) at 24° C. one-month datapoint, multiple frequency sweep needs to be performed in 8° C. increments from 24° C. to 70° C. After performing the frequency sweeps, time-temperature superposition principles were applied using the Williams-Landel-Ferry (WLF equation) to determine shift factors. Master curves at a given reference temperatures (in this case 24° C.) were created and calculated by TRIOS software provided by TA Instruments. Once a master curve at 24° C. is constructed, shear storage modulus with the duration of 1 month is available.

Shear relaxation modulus G(t): The master curve of shear storage modulus can be transformed into shear relaxation modulus using the approximate method of Ninomiya and Ferry equation:

G(t)=G′(ω)−0.40*G″(0.40*ω)+0.014*G″(10ω)|_{ω=1/t}.

The interlayers of the present invention can be formed according to any suitable method. Exemplary methods can include, but are not limited to, solution casting, compression molding, injection molding, melt extrusion, melt blowing, and combinations thereof. Multilayer interlayers including two or more polymer layers may also be produced according to any suitable method such as, for example, co-extrusion, blown film, melt blowing, dip coating, solution coating, blade, paddle, air-knife, printing, powder coating, spray coating, lamination, and combinations thereof.

According to various embodiments of the present invention, the layers or interlayers may be formed by extrusion or co-extrusion. In an extrusion process, one or more thermoplastic resin(s), optional plasticizer(s), and, optionally, one or more additives as described previously, can be pre-mixed and fed into an extrusion device. The extrusion device is configured to impart a particular profile shape to the thermoplastic composition in order to create an extruded sheet. The extruded sheet, which is at an elevated temperature and highly viscous throughout, can then be cooled to form a polymeric sheet. Once the sheet has been cooled and set, it may be cut and rolled for subsequent storage, transportation, and/or use as an interlayer.

Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

The overall average thickness of interlayers according to various embodiments of the present invention can be at least about 10, at least about 15, at least about 20, at least about 25, at least about 30, at least about 35 mils, at least about 40, at least about 45, at least about 50, at least about 55, at least about 60, at least about 65, at least about 70, at least about 75, at least about 80, at least about 85, at least about 90 or more, although other thicknesses are possible depending on the application and desired properties. In one embodiment, the overall average thickness of the interlayers will be about 15 to about 90 gauge. If the interlayer is not laminated between two substrates, its average thickness can be determined by directly measuring the thickness of the interlayer using a caliper, or other equivalent device. If the interlayer is laminated between two substrates, its thickness can be determined by subtracting the combined thickness of the substrates from the total thickness of the multiple layer panel. Although the above refer to thicknesses of an individual interlayer, it should be understood that two or more individual interlayers can be stacked or otherwise assembled together to form a composite interlayer having a greater thickness, which may then be laminated between various types of substrates for certain end use applications.

In some embodiments, one or more polymer layers can have an average thickness of at least about 1, at least about 2, at least about 3, at least about 4, at least about 5, at least about 6, at least about 7, at least about 8, at least about 9, at least about 10, at least about 15, at least about 20, at least about 25, at least about 30 mils or more, depending on the desired properties and end use.

Interlayers according to various embodiments of the present invention may be utilized in a multiple layer panel comprising a layer or an interlayer(s) and at least one substrate onto which the interlayer is laminated. Any suitable substrate may be used and, in some embodiments, may be selected from the group consisting of glass, polycarbonate, acrylic, and combinations thereof. In general, the substrates in a multiple layer panel are formed from rigid and generally transparent materials such as those listed above. However, in other embodiments, the multiple layer panel may include only one rigid substrate, an interlayer and at least one polymer film disposed on the layer or interlayer, forming a multiple layer panel referred to as a “bilayer.” In some embodiments, the interlayer utilized in a bilayer may include a multilayer interlayer, while in other embodiments, a monolithic interlayer may be used. In other embodiments, a polymer film may be included in a multiple layer panel having two rigid substrates, where the polymer film(s) may be between two layers of interlayer, such as encapsulated between two layers of interlayer. The use of a polymer film in multiple layer panels as described herein may enhance the optical character of the final panel, while also providing other performance improvements, such as infrared absorption or reflection. Polymer films differ from polymer layers or interlayers in that the films alone do not provide the necessary penetration resistance and glass retention properties. The polymer film is generally thinner than the sheet and may generally have a thickness in the range of from 0.001 to 0.25 mm, although other thicknesses may be used. Poly(ethylene terephthalate) (“PET”) is one example of a material used to form the polymer film. Examples of suitable bilayer constructs include: (glass)//(interlayer)//(film) and (glass)//(interlayer)//(coated film). Examples of other constructs that are not bilayers where a polymer film may be used include: (glass)//(interlayer)//(film)//(interlayer)//(glass) and (glass)//(interlayer)//(film)//(multiple layer interlayer)//(glass) where the polymer film may have coatings or any other functional layer(s), as previously described.

In embodiments, the layers and interlayers will be utilized in multiple layer panels comprising two substrates, such as, for example, a pair of glass sheets, with the interlayers disposed between the two substrates. Any suitable type of glass may be used to form the rigid glass substrate, such as alumina-silicate glass, borosilicate glass, quartz or fused silica glass, low iron glass, and soda lime glass. The glass substrate may be annealed, thermally-strengthened or tempered, chemically-tempered, etched, coated, or strengthened by ion exchange, or it may have been subjected to one or more of these treatments. The glass itself may be rolled glass, float glass, or plate glass. The glass may have a coating(s) such as a metal coating, infrared reflective coating, and the like, or it may just be colored or pigmented glass. Examples of such constructs would be: (glass)//(interlayer)//(glass) or (glass)//(interlayer)//(glass)//(interlayer)//(glass), where the interlayer can include a monolithic or multiple layered interlayer as described herein. As previously described, the construct may also include one or more polymer films if desired, and each interlayer may be a monolithic or multiple layer interlayer as desired. The thicknesses of the substrates can be in the range of from 0.1 mm to 15 mm or more and each panel can have the same thickness, or the panels can have different thicknesses.

The typical glass lamination process comprises the following steps: (1) assembly of the two substrates and the interlayer(s); (2) heating the assembly via an IR radiant or convective device for a first, short period of time; (3) passing the assembly into a pressure nip roll for the first de-airing; (4) heating the assembly for a short period of time (such as to about 60° C. to about 120° C.) to give the assembly enough temporary adhesion to seal the edge of the interlayer; (5) passing the assembly into a second pressure nip roll to further seal the edge of the interlayer and allow further handling; and (6) autoclaving the assembly at an appropriate temperature (such as between 135° C. and 150° C.) and pressure (such as between 150 psig and 200 psig) for an appropriate time (such as about 30 to 90 minutes), depending on the actual construct and materials used. Other methods for de-airing the interlayer-glass interface, as described according to one embodiment in steps (2) through (5) above include vacuum bag and vacuum ring processes, and both may also be used to form interlayers of the present invention as described herein.

The panels can be used for a variety of end use applications, including, for example, for automotive, railroad, marine, or aircraft windshields and windows, structural architectural panels in buildings or stadiums, decorative architectural panels, hurricane glass, bulletproof glass, and other similar applications. Examples of suitable architectural applications for panels according to embodiments of the present invention can include, but are not limited to, indoor or outdoor stairs or platforms, pavement or sidewalk skylights, balustrades, curtain walls, flooring, balconies, single side balconies, canopies, support beams, glass fins (that may be decorative and/or support structures), support columns, windows, doors, skylights, privacy screens, shower doors, windows for high rise buildings and building entrances, windshields for transportation applications (e.g., automotive, buses, jets, trains, armored vehicles), bullet proof or resistant glass, security glass (e.g., for banks), hurricane proof or resistant glass, airplane canopies, mirrors, solar glass panels, flat panel displays, and blast resistant windows. The glass laminate can be visually clear, translucent, frosted, etched, or patterned.

In one embodiment, the interlayer is a monolithic interlayer comprising a polyesteramide layer comprising a polyesteramide or polyesteramide composition disclosed herein. In one embodiment, the interlayer is a multilayer interlayer comprising at least polyesteramide layer comprising a polyesteramide or polyesteramide composition disclosed herein. In one embodiment, the interlayer is a multilayer interlayer comprising more than one polyesteramide layer comprising a polyesteramide or polyesteramide composition disclosed herein. Other polymer layers, adhesive layers, tie layers, coatings and the like may be included in the interlayer as previously described.

In certain embodiments, the multilayer interlayer further comprises at least one non-polyesteramide layer. In certain embodiments, an adhesive coating may be used, wherein the adhesive coating is at least partially interposed between the non-polyesteramide layer and the polyesteramide layer. In certain embodiments, a tie layer (such as EVA or TPU) may be used between layers or partially disposed between layers of the multilayer interlayer. In certain embodiments, a multilayer panel comprises the layer or interlayer, optionally with other layers or interlayers.

This invention can be further illustrated by the following examples of preferred embodiments thereof, although it will be understood that these examples are included merely for purposes of illustration and are not intended to limit the scope of the invention unless otherwise specifically indicated.

### Examples

### Abbreviations

AD is adipic acid; AZ is azelaic acid; 1,4-BDO is 1,4-butanediol; DDA is 1,12-dodecanedioic acid; 1,4-CHDA: 1,4-cyclohexanedicarboxylic acid; 1,3-CHDA: 1,3-cyclohexanedicarboxylic acid; ECTMS is trimethoxy[2-(7-oxabicyclo[4.1.0]hept-3-yl)ethyl]silane; GPTMS is (3-glycidyloxypropyl)trimethoxysilane; H2-dimer is hydrogenated dimer acid (Pripol™ 1009); MACM: 4,4′-methylenebis(2-methylcyclohexylamine), mixture of isomers; MDEA is N-methyl diethanolamine; ODA is 1,18-octadecanoic acid; PACM: 4,4′-methylenebis(cyclohexylamine), mixture of isomers; PTMG is polytetrahydrofuran diol; SE is sebacic acid; T928 is Tinuvin™ 928 (2-(2H-benzotriaol-2-yl)-6-(1-methyl-1-phenylethyl)-4-(1,1,3,3-tetramethylbutyl)phenol; TCDA is 3(4).8(9)-bis(aminomethyl)tricyclo[5.2.1.0^{2.6}]decane; TMCA: 5-amino-1,3,3-trimethylcyclohexanemethylamine; TMP is trimethylolpropane; CHDMA: 1,4-bis(aminomethyl)cyclohexane; 1,3-CHDMA is 1,3-bis(aminomethyl)cyclohexane; TMCD: 2,2,4,4-tetramethyl-1,3-cyclobutanediol; CHDM: 1,4-cyclohexanedimethanol, MPMD is 2-methylpentamethyldiamine, min: minute(s); TMHD is a mixture of 2,4,4-trimethyl hexanediamine and 2,2,4-trimethyl hexanediamine.

### Gel Permeation Chromatography (GPC)

GPC analysis was performed on an Agilent series 1100 GPC/SEC analysis system with a UV-Vis detector and refractive index detector. The column set used was Polymer Laboratories 5 μm HFIP gel column and guard. The eluent consists of hexafluoroisopropanol with 20 mM tetraethylammonium nitrate. The testing was performed at 35° C. with a flow rate of 0.8 mL/min. The instrument was calibrated with monodisperse polymethylmethacrylate standards (MW: 580 to 3,000,000). The sample was prepared by dissolving 20 mg sample in hexafluoroisopropanol (10 mL). 10 μL isopropanol was added as flow rate marker. The injection volume was 10 μL. The result was reported as polymethylmethacrylate equivalent molecular weights.

### Example 1: Synthesis of Polyesteramide with the Addition of CBC

A 500-mL round bottom flask fitted with a stainless steel stirrer, glass polymer head to allow a nitrogen/vacuum inlet, glass sidearm to allow removal of volatile by-products, and a receiver flask was charged with dodecanedioic acid (92.1 g, 0.40 moles), MACM (45.8 g, 0.19 moles), 1,4-CHDM (30.9 g, 0.215 moles), and TMP (0.13 g, 0.001 moles). Titanium tetraisopropoxide solution (0.014 g/ml in butanol, 1096 μL) was added to provide a catalytic level of 100 ppm elemental titanium based on theoretical polymer yield. The flask was purged twice with nitrogen before immersion in a metal bath that was pre-heated to 180° C. After the contents were at temperature, the agitator was started and maintained at 200 rpm under a gentle nitrogen sweep. Esterification/amidation were allowed to proceed with the collection of water condensate for 40 minutes at 210° C., 30 minutes at 250° C., and 50 minutes at 275° C. At the end of the esterification a clear, colorless melt was obtained. The temperature was maintained at 275° C. and the nitrogen flow terminated and replaced with a vacuum that was gradually ramped down to 2 torr over the course of 5 minutes. After 170 minutes a clear, light yellow melt of high viscosity was obtained, and the vacuum was displaced with nitrogen before 2.71 grams of a 13.7 wt. % solution of CBC in xylenes or 0.38 mol % CBC were added. A moderate amount of foaming was observed and subsided before vacuum was again ramped down to 2 torr and held for 30 minutes with stirring at 25 rpm. After cooling to room temperature, analysis of the polymer yielded an IhV of 1.28 dl/g and a polydispersity by GPC of 3.4.

### Example 2: (Comparative) Synthesis of Polyesteramide without Chain Extender

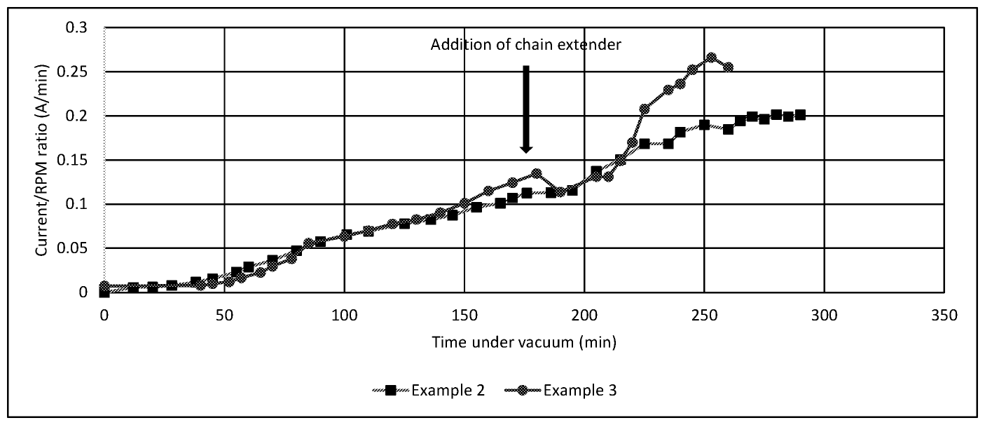

A 1 gallon high pressure autoclave (Parr®) equipped with a stainless steel double propeller stirrer, electrical heating jacket, a nitrogen gas inlet of which the nitrogen flow could be controlled by a thermal mass flow meter, a vacuum line outlet connected to a cold trap, an outlet connected to a condenser and back-pressure regulator, a pressure measurement and a temperature measurement was used to prepare the polyesteramide. The reactor was charged with dodecanedioic acid (921.2 g, 4.0 mol), MACM (457.75 g, 1.92 mol), 1,4-CHDM (307.51 g; 2.13 mol), TMP (0.67 g; 0.005 mol) and titanium tetraisopropoxide solution (0.64 wt. % in isopropanol, 7.19 g). The reactor was purged 3 times with nitrogen, and the pressure inside the reactor was set at 2 atm (1520 torr) by using nitrogen and a continuous nitrogen flow of 2 nL/h through the reactor to maintain an inert atmosphere. The reaction mixture was heated up to 80° C. at which time the agitator was started and maintained at 150 rpm. Esterification and amidation was allowed to proceed with the collection of water condensate for 30 minutes at 210° C., 30 minutes at 250° C. and 40 minutes at 275° C. The temperature was maintained at 275° C. and another amount titanium tetraisopropoxide solution (0.64 wt. % in isopropanol, 7.19 g) was added. The nitrogen flow terminated and replaced with a vacuum that was gradually ramped down to 0.75 torr over the course of 20 minutes. The viscosity build-up was qualitatively measured by monitoring the current consumption of the agitator motor and the stirring speed. Stirring speed was gradually decreased over the course of the experiment to keep the current consumption on the maximum allowable level (2 Amp). After 275 minutes, no further viscosity increase was noticed and the reaction was kept running for another 15 minutes. After that period of time 850 g of the polymer material was withdrawn from the reactor via a bottom drain and cooled down in a water bath. The analysis of the polymer yielded an average IhV of 1.28 dl/g and a polydispersity by GPC of 3.1. The Current/RPM ratio, a qualitative measure of the viscosity of the polymer, over the course of the vacuum stage as a function of time is given in FIG. 1.

### Example 3: Synthesis of Polyesteramide with Addition of CBC

The same experimental set-up, procedure and raw material amounts as described in Example 2 were used for this experiment. Instead of letting the reaction run until no viscosity build-up was seen anymore, the vacuum was displaced with nitrogen after 180 minutes of vacuum stage and a certain amount of CBC (21 w % in THF, 4.9 g solution, 0.19 mol % based on final polymer) was added. Five (5) minutes after the addition, vacuum was ramped down to 0.75 torr over a period of 10 minutes. Seventy (70) minutes after the addition of CBC and thus after 250 minutes in the vacuum stage, no viscosity build-up was observed anymore. The reaction was kept running for another 15 minutes after which 690 g of the polymer material was withdrawn from the reactor via a bottom drain and cooled down in a water batch. The analysis of the polymer yielded an average IhV of 1.31 dl/g and a polydispersity by GPC of 3.7. The current/RPM ratio over the course of the vacuum stage as a function of time is given in FIG. 1.

### Results and Further Examples

Using the procedures outlined in Examples 2 (comparative) and 3, additional Examples (4 to 13) were made using no or different chain extenders to ascertain that high IhV polymer could be made with the introduction of the chain extenders. Table 1 shows that indeed, high IhV can be made by using either Eponex™ Epoxy Resin 1510 (Hexion) or CBC chain extenders. In Example 4, an IhV of 1.325 was achieved with Eponex™ 1510 and in Example 5 an IhV of 1.463 was achieved with the use of CBC.

TABLE 1
Effect of chain extenders on IhV

| | | | Avg. |
|---|---|---|---|
| Example | | Chain | IhV |
| # | Composition | Extender | (dL/g) |
| 2 | DDA(CHDM)48(MACM)0.12(TMP) | No chain | 1.288 |
| | | extender | |
| 3 | DDA(CHDM)48(MACM)0.25(TMP) | 0.19 mol % | 1.305 |
| | | CBC | |
| 5 | DDA(CHDM)48(MACM)0.25(TMP) | 0.76 mol % | 1.463 |
| | | CBC | |
| 13 | DDA(CHDM)48(MACM)0.5(TMP) | No chain | 1.2 |
| | | extender | |
| 4 | DDA(CHDM)48(MACM)0.5(TMP) | 0.53 mol % | 1.325 |
| | | Eponex | |

It appears that the introduction of the chain extenders has a surprising effect on the time required to advance the polycondensation reaction to high IhV. Table 2 shows that the chain extenders speed up the reaction and high IhV is achieved in significantly less time under vacuum. As shown by Example 6 of Table 2, the IhV was reached in 207 minutes under vacuum compared to 290 minutes required to achieve essentially the same IhV without chain extender. Example 2 required about 40% more time under vacuum to achieve the same IhV as Example 6, showing that if a chain extender is used, reactor productivity can be significantly increased.

TABLE 2
Effect of chain extenders on reaction time

| | | | Avg | Time |
|---|---|---|---|---|
| Exam- | | Chain | IhV | under |
| ple | | Ex- | (dL/ | vacuum |
| # | Composition | tender | g) | (min) |
| 2 | DDA(CHDM)48(MACM)0.25(TMP) | n/a | 1.288 | 290 |
| 6 | DDA(CHDM)48(MACM)0.25(TMP) | 0.19 | 1.29 | 207 |
| | | mol % | | |
| | | CBC | | |

One of the key benefits of laminated glass is penetration resistance when it is impacted by objects or when people are thrown (or fall) against it in case of accidents. One way to measure the penetration resistance of laminated glass is to drop a 5 lb. steel ball from different heights and record whether the ball has penetrated through the laminated glass panel. A series of experiments were conducted where 12″×12″ (30 cm×30 cm) panels of laminated glass were made using 3 mm thick glass and interlayers of approximately 0.762 mm thickness (0.030″). The interlayers were compression molded to the target thickness using a hot press and subsequently were laminated using a vacuum bag deairing method and an autoclave. The composition of the interlayers tested is listed in Table 3. The resin for all interlayers was made according to the process described in Examples 2 and 3. The impact testing was conducting at room temperature. Table 3 shows that the Average Break Height of the laminated panels with interlayers that were made by adding chain extenders (Examples 6 to 8) is higher than the control interlayer (Example 2) that was made without chain extenders. All interlayers in Table 3 have impact performance that is desirable for laminated glass, but for those with a chain extender, it is higher.

TABLE 3
Effect of chain extenders on Average
Break Height of laminated glass

| Exam- | | | Avg |
|---|---|---|---|
| ple | | Chain | Break |
| # | Composition | Extender | Height |
| 2 | DDA(CHDM)48(MACM)0.25(TMP) | n/a | 17.2 |
| 6 | DDA(CHDM)48(MACM)0.25(TMP) | 0.19 mol % | 18.4 |
| | | CBC | |
| 7 | DDA(CHDM)48(MACM)0.125(TMP) | 0.19 mol % | 19.4 |
| | | CBC | |
| 8 | DDA(CHDM)48(MACM)0.25(TMP) | 0.38 mol % | 19.2 |
| | | CBC | |

In laminated glass, the optical properties of the interlayer are extremely important since they affect the visual quality of the laminated glass. A critical such property is haze, and very low haze is a desired property for an interlayer and laminated glass panels. Table 4 shows that although there is chemical reaction between the base material and the chain extenders, haze remains beneficially low at less than 2% (or even about 1% or less). The very low haze of all formulations shown in Table 4 indicates that the polymer remains amorphous despite the chain extension reaction, and the haze is similar to that of the polymer without chain extender.

TABLE 4
Effect of chain extenders on Haze of laminated
glass made with PEA interlayers

| Example | | Chain | Haze |
|---|---|---|---|
| # | Composition | Extender | % |
| 2 | DDA(CHDM)48(MACM)0.25(TMP) | n/a | 0.80 |
| 6 | DDA(CHDM)48(MACM)0.25(TMP) | 0.19 mol % | 0.97 |
| | | CBC | |
| 7 | DDA(CHDM)48(MACM)0.125(TMP) | 0.19 mol % | 0.73 |
| | | CBC | |
| 9 | DDA(CHDM)48(MACM)0.25(TMP) | 0.38 mol % | 1.00 |
| | | Eponex ™ | |
| 10 | DDA(CHDM)48(MACM)0.25(TMP) | 0.38 mol % | 0.77 |
| | | Eponex ™ | |

The haze values listed on Table 4 were measured on laminated glass made with 3 mm float glass and 0.76 mm (0.030 inch) interlayers of the compositions listed in Table 4. It can be seen that low haze values are achieved irrespective of the type or level of the chain extender.

Another important property of laminated glass is the adhesion of the interlayer to the glass. High adhesion is desired so that if the glass breaks, glass shards and fragments will continue to adhere to the interlayer and minimize glass fall out to ensure the safety of people and minimize property damage. Table 5 shows the adhesion properties of several PEA interlayers made according to Examples 2 and 3 and laminated using 3 mm glass.

TABLE 5
Effect of chain extenders on the adhesion of PEA
interlayers to glass including a PVB control

| | | | Com- |
|---|---|---|---|
| | | | pressive |
| Exam- | | Chain | Shear |
| ple | | Ex- | Adhesion |
| # | Composition | tender | (MPa) |
| 2 | DDA(CHDM)48(MACM)0.25(TMP) | n/a | 17.5 |
| 6 | DDA(CHDM)48(MACM)0.25(TMP) | 0.19 mol | 23.1 |
| | | % CBC | |
| 7 | DDA(CHDM)48(MACM)0.125(TMP) | 0.19 mol | 20.8 |
| | | % CBC | |
| 9 | DDA(CHDM)48(MACM)0.25(TMP) | 0.38 mol | 21.8 |
| | | % Eponex | |
| 10 | DDA(CHDM)48(MACM)0.25(TMP) | 0.38 mol | 23.0 |
| | | % Eponex | |
| 11 | DDA(CHDM)47(MACM)0.25(TMP) | n/a | 20.1 |
| 12 | DG41 (PVB) | n/a | 17.1 |

The adhesion of the interlayers was measured using the Compressive Shear Adhesion Method at room temperature. Compressive Shear Adhesion (“CSA”) measurements help characterize the level of adhesion between materials. CSA measurements were made with an Alpha Technologies T-20 Tensometer equipped with a special 45° compressive shear sample holder or jig. The laminate is drilled into at least five 1.25 inch diameter discs and kept at room temperature for 24 hours before performing the CSA test. To measure the CSA, the disc is placed on lower half of the jig and the other half of the jig is placed on top of the disc. The cross-head travels at 3.2 mm/min downward causing a piece of the disc to slide relative to the other piece. The compressive shear strength of the disc is the maximum shear stress required to cause the adhesion to fail (measured in mega pascals (“MPa”)).

It can be seen that the incorporation of chain extenders did not adversely or negatively affect adhesion. On the contrary, it appears that the addition of the chain extenders might have increased adhesion to glass compared to the control case of Example 2, and it is comparable or better than the control case of Example 11 which contains a lower level of amide. All of the polyesteramide interlayers have higher adhesion than the control PVB interlayer, Saflex© Structural (DG41), that is commercially available from Eastman Chemical Company.

Another important interlayer property for structural glass is the relaxation modulus of the interlayer at a given temperature and time combination. Table 6 shows the effect that a change in the % MACM level of the material has on the 24° C./1-month relaxation modulus (Examples 2 and 11). From Table 6, it can be seen that the change in MACM has a significant effect on the 24° C./1-month relaxation modulus, as well as on the glass transition temperature (Tg). The MACM level in Table 6 has been measured using a DMTA technique that correlates the Tg to the 24° C./1 mo relaxation modulus. To determine the values, Tg values from several known MACM level samples were used to build a calibration curve, and the MACM levels were then calculated based on measured Tg values.

A TA Discovery HR-2 hybrid rheometer was used for all shear mode characterization measurements, using an 8 mm plate/plate geometry for a single layer of dried, non-processed sample punched by an 8 mm circular die. In order to ensure good bonding between the testing sample and the metal plates, each test specimen was loaded at 65° C. and heated to 150° C. first under program controlled pressure and then cooled to the test temperature for each frequency scan. Strain was varied from 0.01% at 20° C. to 0.1% at 70° C. based on the rigidity of the material, being certain to maintain all measurements within the linear viscoelastic regime. Measurements were performed in about 10° C. increments from 20° C. to 70° C., using a frequency range of 0.01 to 100 Hz with 8 datapoints per decade (33 datapoints per scan per temperature). Time-temperature superposition principles were applied using the Williams-Landel-Ferry (WLF equation) to determine shift factors a_{T}. Master curves at different reference temperatures and the corresponding shift factors were created and calculated by the TRIOS Software provided by TA Instruments.

TABLE 6
Effect of chain extenders on 24° C./1 mo relaxation modulus

| | | | | 24° C./1-month | | |
|---|---|---|---|---|---|---|
| Example | | Chain | Avg IhV | Relaxation | Tg | % MACM |
| # | Composition | Extender | (dL/g) | Modulus (MPa) | (° C.) | IO DMTA |
| 2 | DDA(CHDM)48(MACM)0.25(TMP) | n/a | 1.288 | 60 | 69.1 | 47.9 |
| 11 | DDA(CHDM)47(MACM)0.25(TMP) | n/a | 1.279 | 10 | 67.3 | 47 |
| 6 | DDA(CHDM)48(MACM)0.25(TMP) | 0.19 mol % | 1.29 | 86 | 68.4 | 47.5 |
| | | CBC | | | | |
| 9 | DDA(CHDM)48(MACM)0.25(TMP) | 0.38 mol % | 1.181 | 80 | 68.7 | 47.7 |
| | | Eponex | | | | |

The effect of chain extenders is also shown in Table 6. Examples 6 and 9 show a surprising positive effect of even small levels of chain extenders. Example 6 has 47.5% MACM and one would normally expect it to have a 24° C./1-month relaxation modulus somewhere between the 10 MPa and 60 MPa of Examples 11 and 2, and possibly close to an interpolated value of 37.8 MPa. Surprisingly, its 24° C./1-month relaxation is 86 MPa, a 127% improvement over the expected value based on its % MACM level. Example 6 contains 0.19% CBC and apparently the CBC chain extender drives the 24° C./1-month relaxation modulus improvement. In addition, Example 6 has practically the same IhV level as the Comparative Examples 2 and 11.

A similar effect is evident with Example 9 which contains 0.38% Eponex chain extender. Based on the 47.7% MACM level of Example 9, it would have been expected to have a 24° C./1-month relaxation modulus near an interpolated value of 48.9 MPa. As can be seen in Table 6, Example 9 has a 24° C./1-month relaxation modulus of 80 MPa, a 63.4% improvement over the expected value. In addition, the IhV of Example 9 is actually lower than the IhV of the Comparative Examples 2 and 11. Generally, IhV correlates with MW so Example 9 would have been expected to relax faster due to the lower IhV (and MW), but it actually shows slower relaxation, due to the effect of the Eponex™ Epoxy Resin 1510 (Hexion) chain extender.

Table 7 shows the effect that the concentration of CBC chain extender has on the Molecular Weight of the resulting polymers. It can be seen that as the concentration of CBC is increased, the Mw and Mz also increase and very high Mw and Mz can be achieved as shown by Example 5. It can also be noted that, if the amount of chain extender is increased, the polydispersity of the final polyesteramide increases.

Table 8 shows the effect that the concentration of Eponex™ 1510 chain extender has on the Molecular Weight of the resulting polymers. It can be seen that very high Mw and Mz can be achieved as shown by Example 4 compared to a control (Example 13).

TABLE 7
Effect of CBC chain extender on the Mw and Mz molecular weight

| Example | | Chain Extender | | | | |
|---|---|---|---|---|---|---|
| # | Composition | (mol %) | Mn | Mw | Mz | PD |
| 2 | DDA(CHDM)48(MACM)0.25(TMP) | n/a | 30013 | 93057 | 200323 | 3.10 |
| 6 | DDA(CHDM)48(MACM)0.25(TMP) | 0.19 CBC | 25766 | 95193 | 207510 | 3.70 |
| 7 | DDA(CHDM)48(MACM)0.125(TMP) | 0.19 CBC | 28573 | 99621 | 210073 | 3.50 |
| 8 | DDA(CHDM)48(MACM)0.25(TMP) | 0.38 CBC | 24548 | 98904 | 234408 | 4.03 |
| 5 | DDA(CHDM)48(MACM)0.25(TMP) | 0.76 CBC | 27480 | 125861 | 312459 | 4.60 |

TABLE 8
Effect of Eponex 1510 chain extender on the Mw and Mz molecular weight

| Ex. | | Chain | | | | |
|---|---|---|---|---|---|---|
| # | Composition | Extender (mol %) | Mn | Mw | Mz | PD |
| 13 | DDA(CHDM)48(MACM)0.5(TMP) | n/a | 22708 | 90948 | 221241 | 4.0 |
| 4 | DDA(CHDM)48(MACM)0.5(TMP) | 0.53 Eponex ™ | 22250 | 121382 | 359421 | 5.5 |

The invention has been described in detail with particular reference to certain embodiments thereof, but it will be understood that variations and modifications can be effected within the spirit and scope of the invention.

1. A polyesteramide composition comprising residues of:
a. at least one diacid;
b. about 10 to about 90 mole percent of a diol;
c. about 10 to about 90 mole percent of a diamine; and optionally
d. a multifunctional reactant having at least three functional groups chosen from carboxylic acid, amine, and hydroxyl groups;
wherein the sum of diacid equivalents is about 100 mole percent and the sum of diol and diamine equivalents is about 100 mole percent; and
e. about 0.01 to about 10 weight percent, based on the total weight of the polyesteramide comprised of a., b., c., and optionally d., of a chain extender reactive with groups chosen from carboxyl, amino, and hydroxyl groups,
and wherein said polyesteramide exhibits an inherent viscosity of about 0.6 to about 2.0 dL/g.

2. The polyesteramide composition of claim 1, wherein the diacid is chosen from aliphatic dicarboxylic acids having 3 to 36 carbon atoms, cycloaliphatic dicarboxylic acids having 8 to 14 carbon atoms and aromatic dicarboxylic acids having 8 to 16 carbon atoms.

3. The polyesteramide composition of claim 1, wherein the diacid is chosen from oxalic acid, malonic acid, succinic acid, glutaric acid, adipic acid, pimelic acid, azelaic acid, sebacic acid, decanedioic acid, dodecanedioic acid, glycolic acid, 1,2-cyclohexane dicarboxylic acid, 1,3-cyclohexane dicarboxylic acid, 1,4-cyclohexane dicarboxylic acid, phthalic acid, isophthalic acid, terephthalic acid, octanedioic, and 2,6-naphthalene dicarboxylic acid.

4. The polyesteramide composition of claim 1, wherein the diacid is a dimer acid chosen from 9-[(Z)-non-3-enyl]-10-octylnonadecanedioic acid and 9-nonyl-10-octylnonadecanedioic acid.

5. The polyesteramide composition of claim 1, wherein the glycol is chosen from aliphatic, alicyclic, and aralkyl glycols.

6. The polyesteramide composition of claim 1, wherein the glycol is chosen from ethylene glycol; 1,2-propandiol; 1,3-propanediol; 1,4-butanediol; 1,5-pentanediol; 1,6-hexanediol; 2,2-dimethyl-1,3-propanediol; 1,2-cyclohexane dimethanol; 1,3-cyclohexane dimethanol; 1,4-cyclohexane dimethanol; 2,2,4,4-tetramethyl-1,3-cyclobutanediol; isosorbide; p-xylylenediol; diethylene glycol; triethylene glycol; tetraethylene glycol; polyethylene glycols; dipropylene glycol; dibutylene glycol; polyalkylene ether diols chosen from polypropylene glycol and polytetramethylene glycol.

7. The polyesteramide composition of claim 1, wherein the diamine is chosen from alkylenediamines having 2 to 12 carbon atoms, cycloalkylenediamines having 6 to 17 carbon atoms, and aromatic diamines having 8 to 16 carbon atoms.

8. The polyesteramide composition of claim 1, wherein the diamine is chosen from 1,2-ethylenediamine; 1,6-hexamethylenediamine; 1,4 and 1,3-cyclohexanediamine; 1,4 and 1,3-cyclohexane bismethylamine; 4,4′-methylenebis(cyclohexylamine); 4,4′-methylenebis(2-methylcyclohexylamine); and 2,2,4,4-tetramethyl-1,3-cyclobutanediamine; 2,2,4-trimethylhexamethylenediamine; 4-oxaheptane-1,4-diamine; 4,7-dioxadecane-1,10-diamine; 1,4-cyclohexanebismethylamine; 1,3-cyclohexanebismethylamine; 1,7-heptamethylenediamine; and 1,12-dodecamethylenediamine.

9. The polyesteramide composition of claim 1, wherein the multifunctional reactant is chosen from trimellitic acid, trimellitic anhydride, trimesic acid, pyromellitic acid, pyromellitic dianhydride, pentaerythritol, glycerol, trimethylolpropane, trimethylolethane, erythritol, threitol, dipentaerythritol, sorbitol, and dimethylolpropionic acid.

10. The polyesteramide composition of claim 1, wherein the chain extender is chosen from difunctional compounds chosen from diepoxides, diisocyanates, biscaprolactams, bisoxazolines, carbodiimides, and dianhydrides.

11. The polyesteramide composition of claim 1, wherein the number average molecular weight (Mn) is greater than about 10,000 Daltons.

12. The polyesteramide composition of claim 1, wherein the glass transition temperature (T_{g}) is about 0° C. to about 200° C., as measured by dynamic mechanical thermal analysis.

13. A polyesteramide composition comprising residues of:
a. a diacid chosen from sebacic acid and dodecanedioic acid;
b. about 40 to about 60 mole percent of 1,4-cyclohexanedimethanol;
c. about 40 to about 60 mole percent of 4,4′-methylenebis(2-methylcyclohexylamine); and
d. about 0.1 to about 0.5 mole percent of trimethylolpropane;
wherein the sum of diacid equivalents is about 100 mole percent and the sum of diol and diamine equivalents is about 100 mole percent; and
e. about 0.01 to about 10 weight percent, based on the total weight of the polyesteramide comprised of a., b., c., and optionally d., of a chain extender reactive with groups chosen from carboxyl, amino, and hydroxyl groups.

14. An interlayer comprising the polyesteramide composition of claim 1.

15. A multiple layer interlayer comprising:
a first layer comprising a polyesteramide composition comprising residues of:
a. at least one diacid;
b. about 10 to about 90 mole percent of a diol;
c. about 10 to about 90 mole percent of a diamine; and optionally
d. a multifunctional reactant having at least three functional groups chosen from carboxylic acid, amine, and hydroxyl groups;
wherein the sum of diacid equivalents is about 100 mole percent and the sum of diol and diamine equivalents is about 100 mole percent; and
e. about 0.01 to about 10 weight percent, based on the total weight of the polyesteramide composition comprised of a., b., c., and optionally d., of a chain extender reactive with groups chosen from carboxyl, amino, and hydroxyl groups,
wherein said polyesteramide exhibits an inherent viscosity of about 0.6 to about 2.0 dL/g; and
a second layer comprising a polymer composition which is different than the polyesteramide composition of the first layer.

16. A laminate structure, comprising:
a. a top panel layer;
b. a polyesteramide composition comprising residues of:
i. at least one diacid;
ii. about 10 to about 90 mole percent of a diol;
iii. about 10 to about 90 mole percent of a diamine; and optionally
iv. a multifunctional reactant having at least three functional groups chosen from carboxylic acid, amine, and hydroxyl groups; wherein the sum of diacid equivalents is about 100 mole percent and the sum of diol and diamine equivalents is about 100 mole percent; and
v. about 0.01 to about 10 weight percent, based on the total weight of the polyesteramide composition comprised of i., ii., iii., and optionally iv., of a chain extender reactive with groups chosen from carboxyl, amino, and hydroxyl groups, wherein said polyesteramide exhibits an inherent viscosity of about 0.6 to about 2.0 dL/g; and optionally
c. a bottom panel layer.

17. The laminate structure of claim 16, wherein the panel comprises glass.

18. A shaped or formed article comprising the polyesteramide of claim 1.

19. The article of claim 18, wherein the article is chosen from a film, a sheet, a container, packaging material, battery housing, medical device housing, medical device tubing, industrial articles and connectors.
